(19) United States
(12) Patent Application Publication
(10) Pub. No.: US 2025/0355958 A1
(43) Pub. Date: Nov. 20, 2025

(54) On-Demand Generative Response Simplification

(71) Applicant: Google LLC, Mountain View, CA (US)

(72) Inventor: Ali Tawfiq, Brooklyn, NY (US)

(21) Appl. No.: 19/208,336

(22) Filed: May 14, 2025

Related U.S. Application Data
(60) Provisional application No. 63/647,355, filed on May 14, 2024.

(51) Int. Cl. G06F 16/9538

(52) U.S. Cl. CPC G06F 16/9538

(57) ABSTRACT

The present disclosure provides methods, systems, and devices for providing simplified versions of model responses. A computing system receives a user query. The computing system generates a first model input to a generative model based on the user query. The computing system receives a first model output from the generative model. The computing system transmits the first model output for display to a user in a user interface. The computing system receives a simplification request associated with the first model output. The computing system generates a second model input, the second model input including one or more instructions to provide a simplified explanation of the first model input. The computing system receives a second model output from the generative model, the second model output comprising a simplified version of the first model output. The computing system transmits the second model output for display to a user.

### PRIORITY CLAIM

The present application is a continuation of U.S. Application No. 63/647,355 having a filing date of May 14, 2024. Applicant claims priority to and the benefit of each of such applications and incorporates all such applications herein by reference in its entirety.

### FIELD

The present disclosure relates generally to generative models. More particularly, the present disclosure relates to producing simplified versions of a generative search response.

### BACKGROUND

Understanding the world at large can be difficult. Whether an individual is trying to understand what the object in front of them is, trying to determine where else the object can be found, and/or trying to determine where an image on the internet was captured from, text searching alone can be difficult. In particular, users may struggle to determine which words to use. Additionally, the words may not be descriptive enough and/or abundant enough to generate desired results.

In addition, the content being requested by the user may not be readily available to the user based on the user not knowing where to search, based on the storage location of the content, and/or based on the content not existing. The user may be requesting search results based on an imagined concept without a clear way to express the imagined concept.

### SUMMARY

Aspects and advantages of embodiments of the present disclosure will be set forth in part in the following description, or can be learned from the description, or can be learned through practice of the embodiments.

One example aspect of the present disclosure is directed to computer-implemented method. The method can be performed by a computing system comprising one or more processers. The one or more operations comprise receiving, by a computing system with one or more processors, a user query. The operations further comprise generating, by the computing system, a first model input to a generative model based on the user query. The operations further comprise receiving, by the computing system, a first model output from the generative model. The operations further comprise transmitting, by the computing system, the first model output for display to a user in a user interface. The operations further comprise receiving, by the computing system, a simplification request associated with the first model output. The operations further comprise generating, by the computing system, a second model input, the in second model input including one or more instructions to provide a simplified explanation of the first model input. The operations further comprise receiving, by the computing system, a second model output from the generative model, the second model output comprising a simplified version of the first model output. The operations further comprise transmitting, by the computing system, the second model output for display to a user in a user interface.

Another example aspect of the present disclosure is directed to a computing system for search result distillation. The system can include one or more processors and one or more non-transitory computer-readable media that collectively store instructions that, when executed by the one or more processors, cause the computing system to perform operations. The operations can include obtaining a query. The query can include a plurality of features. The operations can include processing the query with a search engine to determine a plurality of search results based on the plurality of features. The operations can include processing the query with a classification model to determine a query classification descriptive of a particular query type of a plurality of different query types. The operations can include processing the query, a subset of plurality of search results, and a particular prompt with a generative model to generate a plurality of sub-topics and a plurality of sub-topic queries in response to the query classification being descriptive of the particular query type. In some implementations, the plurality of sub-topics can be associated with a topic of information responsive to the query. The plurality of sub-topic queries can be associated with the plurality of sub-topics. The operations can include processing the plurality of sub-topic queries to determine a plurality of sub-topic search result sets. Each of the plurality of sub-topic search result sets can be associated with a different sub-topic query of the plurality of sub-topic queries. The operations can include processing the query, the plurality of sub-topics, and the plurality of sub-topic search result sets with the generative model to generate a multi-part response including a plurality of sub-topic headers and a plurality of sub-topic descriptions. The operations can include providing the multi-part response for display in a search results interface.

In some implementations, the operations can include processing the query with a first query classification model to determine a first query classification and determining to provide the query to the classification model based on the first query classification. The operations can include providing the query and the subset of plurality of search results to the generative model based on the first query classification and processing the query and the subset of plurality of search results with the generative model to generate a first model-generated response. The first model-generated response can include a response to the query generated based on the content of the subset of plurality of search results. The operations can include providing the first model-generated response for display within the search results interface.

In some implementations, the operations can include providing a portion of the plurality of the search results for display with a selectable user interface element associated with preforming generative model processing before processing the query, the subset of the plurality of search results, and the particular prompt with the generative model to generate the plurality of sub-topics and the plurality of sub-topic queries. The operations can include obtaining a selection of the selectable user interface element and providing the query, the subset of the plurality of search results, and the particular prompt to the generative model based on the selection.

In some implementations, providing the multi-part response for display in the search results interface can include providing the multi-part response for display with a portion of the plurality of search results. Processing the query, the plurality of sub-topics, and the plurality of sub-topic search result sets with the generative model to generate the multi-part response can include generating an introduction and a conclusion comprising information responsive to the query, generating the plurality of sub-topic headers based on the plurality of sub-topics, generating the plurality of sub-topic descriptions based on the plurality of sub-topic search result sets, and generating the multi-part response comprising a structured format of the introduction, the plurality of sub-topic headers, the plurality of sub-topic descriptions, and the conclusion.

In some implementations, the plurality of sub-topic queries can include a plurality of model-generated queries generated to obtain information associated with the plurality of sub-topics. The plurality of sub-topic search result sets can be determined based on one or more knowledge graphs. In some implementations, the multi-part response can include the plurality of sub-topic headers are presented in bold. The plurality of sub-topic descriptions can be collapsable within the search results interface. Each of the plurality of sub-topic descriptions can be presented with one or more respective search results from the plurality of sub-topic search result sets.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example query response system according to example embodiments of the present disclosure.

FIG. 2 depicts a block diagram of an example query response system according to example embodiments of the present disclosure.

FIG. 3 depicts a flow diagram for generating a simplified version of an explanation produced by a sequence processing model 120 according to example embodiments of the present disclosure.

FIG. 4 depicts a flow diagram for generating a simplified version of an explanation produced by a sequence processing model according to example embodiments of the present disclosure.

FIG. 5 depicts an example user interface for displaying model responses generated by a generative model according to example embodiments of the present disclosure.

FIG. 6A depicts an example user interface for displaying model responses generated by a generative model according to example embodiments of the present disclosure.

FIG. 6B depicts an example user interface for displaying model responses generated by a generative model according to example embodiments of the present disclosure.

FIG. 7 depicts a flow chart diagram of an example method to perform according to example embodiments of the present disclosure.

FIG. 8 depicts a flow chart diagram of an example method to perform multi-part response generation according to example embodiments of the present disclosure.

FIG. 9 depicts a block diagram of an example multi-pipeline system according to example embodiments of the present disclosure.

FIG. 10 depicts a block diagram of an example breakdown pipeline system according to example embodiments of the present disclosure.

FIG. 11 depicts a block diagram of an example multi-part response generation system according to example embodiments of the present disclosure.

FIG. 12 depicts an illustration of an example multi-part response according to example embodiments of the present disclosure.

FIG. 13 depicts an illustration of example model-generated responses according to example embodiments of the present disclosure.

FIG. 14A depicts a block diagram of an example computing system that performs search result processing according to example embodiments of the present disclosure.

FIG. 14B depicts a block diagram of an example computing system that performs search result processing according to example embodiments of the present disclosure.

Reference numerals that are repeated across plural figures are intended to identify the same features in various implementations.

### DETAILED DESCRIPTION

Generally, the present disclosure is directed to a system for providing simplified explanations of responses generated by generative models included in a search response system. In particular, the generative models can include sequence processing models such as, for example, so-called large language models (“LLMs”) and/or large multi-modal models (“LMMs”). In some examples, when a response is generated by a sequence processing model, the response can be displayed in a user interface at the user device. The user interface can also include a selectable element that allows the user to request a simplified version of the response. In some instances, this selectable element can be referred to as a “simplify user interface element”. In some examples, the simplify user interface element is only displayed if the query or the response is classified as being appropriate to simplify.

In some implementations, if the user selects the simplify user interface element, the search response system can generate another input to the sequence processing model that includes instructions that prompt the sequence processing model to generate a simplified version of the prior response. In some examples, the simplified version of the response is generated prior to user selection of the simplify user interface element and/or without being specifically requested by the user. In this manner, the simplified response can be available for immediate display to the user if the user selects the simplify user interface element.

Through the use of the simplify user interface element and associated techniques, users who do not initially understand a particular response from a sequence processing model can easily and quickly request a more simplified version of that response. The simplified versions of the response can include or be based on application of a variety of techniques to simplify the answer including, but not limited to, stories, relatable facts, analogies, real-world examples, and so on.

In some examples, each user that provides a user query to a search response system that leverages a sequence processing model (or other machine-learned model) may have a different level of understanding of the topic of the user query. As a result, the response generated by the search response system (e.g., using the sequence processing model) may not be clearly understandable to all users who submit a particular query. In some examples, a user may have to submit multiple queries to the search system to increase the likelihood that the response proposed by the model is at a level that the user can understand.

The systems and methods disclosed herein can generate a simplified version of response generated by a sequence processing model. To do so, users can be provided with an option (e.g., a user-selectable interface element) within the user interface that allows the user to request a simplified explanation of the response. For example, if the user submits the query and the sequence processing model produces a response, the user can review that response and determine that the response is difficult for them to understand or that they would otherwise prefer a simplified response. The user can then select the simplify button in the user interface, that will cause a simplified explanation to be presented.

The systems and methods disclosed herein can also provide a “breakdown” user interface element that, when selected, generates a structured multi-part response to the query. The structured multi-part response can include a model-generated response that is responsive to the query and includes detailed information about a plurality of sub-topics (e.g., three to six sub-topics) associated with the response. For example, the structured multi-part response can include a header (e.g., a descriptive title associated with a main concept of the section) and description for each of the plurality of sub-topics along with a response introduction and a response conclusion.

The structured model-generated multi-part response can be provided in search result interfaces to provide detailed responses to queries that may be complex and may have a multi-faceted answer. Providing the structured model-generated multi-part response with search results can provide an intuitive response to a query and may provide an information primer that a user may build off of when they review the contents of the search results. Generation of the structured model-generated multi-part response may be triggered based on the selection of a user interface element within the search results interface, which may be provided based on the output of one or more query classifiers.

Some topics can be complex and may have several sub-topics that may provide key insight on the topic. Understanding the complex topics from search results can be difficult as the information may be scattered across several different search results with each search result only including a fragment of the relevant information. Moreover, general model-generated responses may provide a high-level response to queries about the topic; however, the responses may lack the key insight associated with the sub-topics.

The systems and methods disclosed herein can generate the structured multi-part response based on the outputs of one or more search engines, one or more generative models, and/or one or more classification models. For example, a query can be obtained from a user computing device. The query can be processed with a first classification model to determine whether an artificial intelligence response option is to be provided (e.g., is the query a candidate for model-generated response generation). If the query is a candidate for model-generated response generation, the query (and/or search results associated with the query) may be processed with a second classification model to determine whether a breakdown user interface element is to be provided (e.g., whether the query is a query type that may be associated with a complex topic that may have multiple sub-topics to breakdown for understanding the topic). The query can be processed with a search engine to determine a plurality of search results. The plurality of search results may then be provided for display with the breakdown option (e.g., a selectable breakdown user interface element).

In response to the breakdown user interface element being selected, the query and the search results can be provided to a generative model (e.g., a machine-learned blueprint model). The generative model (e.g., the machine-learned blueprint model) can process the query and the search results to determine a plurality of sub-topics associated with a response to the query and to generate a plurality of model-generated sub-topic queries based on the plurality of sub-topics. Each of the plurality of model-generated sub-topic queries can be a query generated to obtain additional information associated with a respective sub-topic of the plurality of sub-topics. The plurality of model-generated sub-topic queries can then be processed (e.g., with a search engine) to determine a plurality of sub-topic result sets associated with the plurality of respective model-generated sub-topic queries. The query, the plurality of sub-topics, the plurality of sub-topic result sets, and/or the search results can then be processed with a generative model (e.g., a response generation model) to generate the multi-part response. The multi-part response can include a structured response with an introduction, a conclusion, a plurality of sub-topic headers, and/or a plurality of sub-topic descriptions (which may be collapsable and/or expandable with the search results interface). The multi-part response can then be provided for display within the search results interface.

The multi-part response can provide details about foundational information on topics that may be complex. For example, the response may be associated with a scientific response, while each section of the multi-part response may be associated with a different scientific law or theory that provides backing for the response. Alternatively and/or additionally, the query may be associated with a historical topic, and the response may include a general response to the query along with a plurality of different sections explaining different historical events that may have caused and/or been caused by the historical information that is directly responsive to the query (e.g., the query may be “who won X war?”, the general response may include “Y won the war,” and the different sub-topic sections can be associated with different battles, the final treaty, the aftermath, and/or important people in the war).

The systems and methods of the present disclosure provide a number of technical effects and benefits. As one example, the systems and methods can provide a dedicated response pipeline for broken down and/or simplified responses (e.g., one or more dedicated pipelines can be leveraged for specialized model-generated responses based on search results). In particular, the systems and methods disclosed herein can utilize a plurality of classifications models to determine when a search query is associated with a candidate topic for sub-topic breakdown and/or simplification and can generate specialized model-generated responses based on the determination. The specialized model-generated responses may be generated based on dedicated pipelines that may include generating additional queries, obtaining additional information, and then processing the query and the additional information with a generative model to generate the specialized model-generated response.

Another technical benefit of the systems and methods of the present disclosure is the ability to leverage sub-topic determination, search result processing, query generation, follow-up queries, and/or one or more generative models to generate multi-part structured responses. The multi-part structured responses can be responsive to a query while providing a detailed breakdown of each of a plurality of sub-topics associated with the response.

Another example of technical effect and benefit relates to improved computational efficiency and improvements in the functioning of a computing system. For example, the systems and methods disclosed herein can leverage the classification models to limit the generative model processing to instances determined to be useful for breakdown, simplification, and/or artificial intelligence processing. The reduction of generative model processing instances can reduce the computational resources utilized to provide search result interfaces with artificial intelligence options.

With reference now to the Figures, example embodiments of the present disclosure will be discussed in further detail.

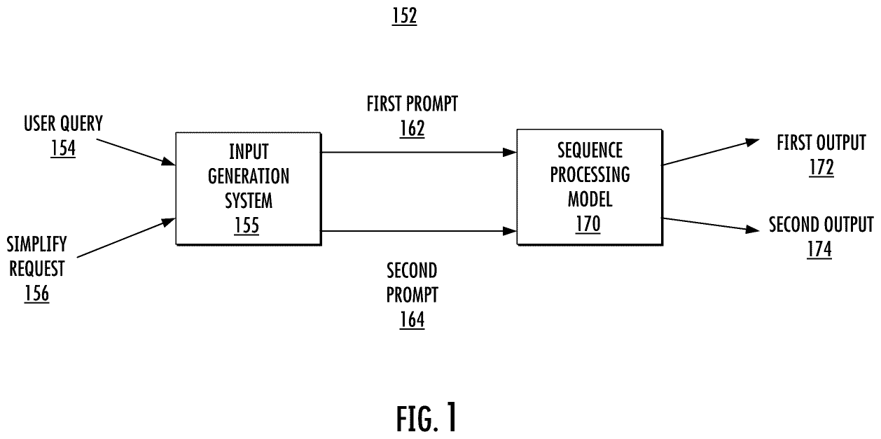

FIG. 1 depicts a block diagram of an example query response system 152 according to example embodiments of the present disclosure. In some implementations, the query response system 152 is configured to receive, and/or obtain, a user query from a user computing device. For example, the user computing device can receive, via a user input device, user input associated with a query from the user. A user can input text into a text query field of a computing application associated with the query response system 152 (e.g., a user interface of a website displayed in a web browsing application) to input the user query 154.

The user query 154 can be transmitted to the query response system 152 via one or more computing networks connecting the user computing device and a remote server system that provides the query response system 152 as a service. The query response system 152 can include an input generation system 160. The input generation system 160 can receive the user query 154. The input generation system 160 can generate a first prompt 162 to a sequence processing model 170 based on the user query 154. The first prompt 162 can include the user query 154, any history of queries submitted by the user, any history of previous responses provided by the query response system, contextual data associated with the subject or topic of the query, instructions describing the format and/or contents of the response, and any relevant user information.

The first prompt 162 can be provided to the sequence processing model 170 (or other machine-learned model). The model can be a sequence processing model 130 or other generative model. The generative model can be trained to process input data and generate model-generated content items, which may include a plurality of predicted words, pixels, signals, and/or other data.

The model-generated content items may include novel content items that are not the same as any pre-existing work. The sequence processing model 170 can leverage learned representations, sequences, and/or probability distributions to generate the content items, which may include phrases, storylines, settings, objects, characters, beats, lyrics, and/or other aspects that are not included in pre-existing content items.

The sequence processing model 170 can generate a first output 172 based on the first prompt 162. The output generated by the sequence processing model 170 can be a response to the user query 154. For example, if the user query is a factual question such as “What year was John F. Kennedy elected?”, the response can include the date 1960. However, other queries can be directed towards significantly more complex and challenging questions. For example, an example of a complex query can be “What is string theory and what is it used to explain?” The response to this query may be long and include complex explanations and reasoning.

The first output 172 can be an explanation or response to the user query that can include text, audio, animated images, video, audio, and so on. The first output 172 can be provided to the user computing device for display to the user. For example, the first output can be displayed in a user interface in the user computing device. The user interface can also include one or more user-selectable interface elements. The user selectable interface elements can include a “simplify” button. If the user selects the “simplify” button, the user computing system can, based on instructions associated with the application displaying the user interface, generate a simplify request 156 associated with the first output.

The input generation system 160 can receive the simplify request 156. The simplify request 156 can include information identifying the first output 172 and indicating the user has requested a simplified version of the first output 172. The input generation system 160 can, in response to receiving the simplify request, generate a second prompt 164. The second prompt 164 can include the user query 154, the first output 172, instructions to provide a simplified version of the first output 172, as well as one or more other pieces of contextual information that may be useful.

In some examples, the second prompt can include explicit instructions that instruct the sequence processing model 130 on how to generate a simplified response. For example, the instructions can indicate that the simplified response should use analogies or simple stories to convey the main ideas of the original response. In some examples, the second prompt can include information detailing the type of wording used in the second response.

Once the second prompt 164 has been generated, the second prompt 164 can be provided to the sequence processing model 170. In the sequence processing model 170 can process the second output 164 and generate a second response 136. In some examples the second response can include information conveying the main ideas of the first output 172 but in a simplified and less complex form. In some examples, with the second output 174 can exclude extraneous details or complicating factors such that the second response one through 6 can provide an understandable explanation.

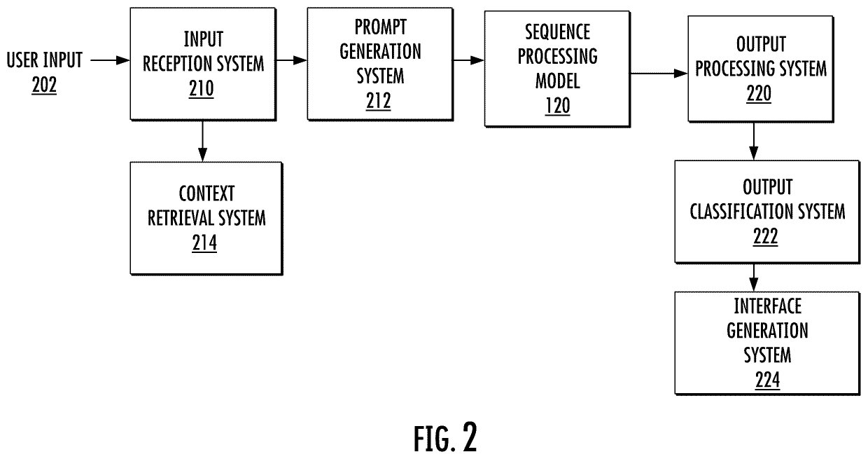

FIG. 2 depicts a block diagram of an example query response system 152 according to example embodiments of the present disclosure. A user can access a query response system 102 via a computer application at the user computing device. In some examples, the user can use a web browser to access a web site associated with the query response system 102. The web site can include an input field that allows a user to input the text of a query. In some examples, the query can include audio content, image content, or video content.

The user computing device can, once the user input 202 has been received from the user, transmit the user input 202 to the query response system 102. The query response system 102 can include an input reception system 210. The input reception system 210 can analyze the user input 202 to determine a proper response. In some examples, the input reception system 210 can access the context retrieval system 214. For example, if the input reception system 210 determines that the user input 202 is associated with a previous query, the context retrieval system 214 can access the previously submitted query (or queries) and any responses generated by the query response system.

In this way, if the user has previously submitted one or more queries and received one or more responses, that information can be used as context for responding to the current user input 202. The input reception system 210 can provide the user query, and any data received from the context retrieval system 214, to the prompt generation system 212. The prompt generation system 212 can generate a first prompt based on the user input 202.

For example, the user input 202 can be a query that seeks a response to a question. The prompt can include the query, information about the topic of the query, the contextual data received from the context retrieval system 214. The prompt generation system 212 can provide the first prompt to the sequence processing model 120. The sequence processing model 120 can generate a first model output based on the first prompt. The first model output can be provided to the output processing system 220.

The output processing system 220 can format the first model output as needed to display in the user interface system. In some examples, the first model output can refer to images or diagrams to be included and the output processing system 220 can generate or retrieve any media content for use in the first model output. The output classification system 222 can determine whether the first model output is a candidate for which a simplified version may be useful.

For example, if the user query is a simple factual question, the output classification system can determine that no simplified version is needed. If the query is “what is the capital of Canada?”, the first model output can be very simple, and no simplification is likely to be needed. In other examples, the output classification system 222 can determine that the first model output is sufficiently complicated that a simplification may be useful.

The interface generation system 224 can generate instructions for displaying the first model output on the user computing device. For example, the interface generation system can include instructions to generate a webpage interface to display the first model output (e.g., html, JavaScript, and so on). If the output classification system 222 determines that simplification is applicable to the first model output, the interface generation system 224 can include a “simplification” interface button in the user interface in which the first model output is displayed. In other examples, the system can evaluate the query to determine whether it is associated with topics for which simplification is applicable. For example, the system can include a classifier that generates, for each query, a determination whether the user query is associated with a topic for which simplification can be offered. For example, queries associated with education topics may be classified as being associated with simplification.

The interface generation system 224 can transmit the first model output (and any associated formatting information for the user interface) ed to the user computing device for display. In some examples, the user may determine that the content of the first model output is too complicated or too hard to understand. In response, the user can select the “simplify” button in the user interface. Selection of the simplify button can cause the user computing device to generate a simplify request.

The simplify request can be transmitted to the user query response system 102 as user input 202. The input reception system 210 can receive the simplify request. The simplify request can include information indicating the specific first model output for which the simplification is requested. The input reception system 210 can use the context retrieval system 214 to determine the specific first modal output associated with the simplify request.

The context retrieval system 214 can access the original user query, the first model output, information about the topic of the user query, instructions to generate a simplified answer, and any other contextual information. The context retrieval system 214 can provide the data to the input reception system 210. The prompt generation system 212 can use this information to generate a second prompt (e.g., the second model input).

The second prompt is provided to the sequence processing model 120. The sequence processing model 120 can use the second prompt to generate a second model output. The second model output can be a simplified version of the first model output. The second model output can exclude complex or high level words and can describe the general idea of the first model output using analogies, stories, and simple examples. In some examples, the specific details used to simplify the first model output can be based on information about the user (e.g., stored in the user profile) that describe the user's current level of understanding and relate the ideas to concepts the user already understands.

Once the second model output has been generated, the output processing system 220 can prepare the output for display. Specifically, the output processing system 220 can format the data and supply any needed media not produced by the sequence processing model 120. For example, if the output includes any needed images, videos, animations, and so on, that media can be produced by a secondary generative model based on instructions in the second model output.

In some examples, the sequence processing model 120 produces a plurality of potential second model outputs. If so, the output process system 220 can evaluate each candidate second model output and generate a score for each candidate second model input. The candidate second model outputs can be ranked according to the generated scores. The highest ranked second model output can be provided to the output classification system 222.

In some examples, the output classification system 222 can determine that the second model output has already been simplified. As such, the user interface can include user interface elements that allow the user to switch between the detailed first model output and the simplified second model output as needed. In some examples, the simplified second model output can be generated prior to receiving the simplification request. The simplified second model output can be displayed when the simplification request is received.

The interface generation system 224 can update the user interface at the user computing system to display the simplified second model output. In some examples, the user interface includes a user interface element to enable a user to switch between displaying the original first model output and the simplified second model output. In some examples, both model outputs can be displayed simultaneously.

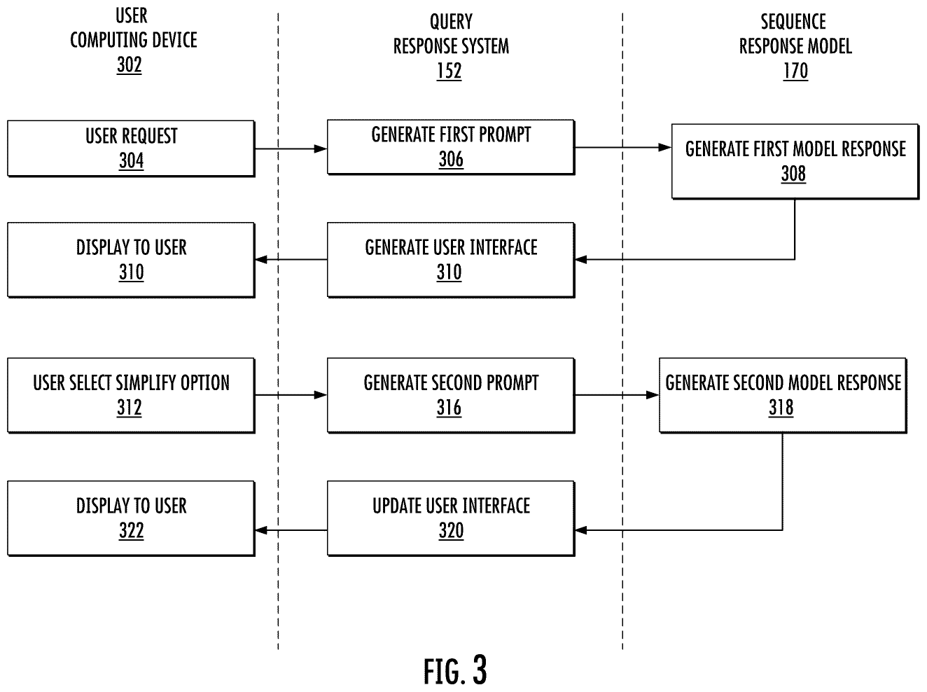

FIG. 3 depicts a flow diagram for generating a simplified version of an explanation produced by a sequence processing model 120 according to example embodiments of the present disclosure. In this example, a user computing device 302 can execute a computer application for use by a user. The application can be associated with the query response system 102. The user can input a request using the computing application. For example, the request can be a query or other question about a particular topic.

The user request through four can be transmitted from the user computing device 302 to the query response system 102. The query response system 302 can receive the user request 304, and in response, generate prompt 306. As noted above, the prompt can include the user request three or four, instructions to the sequence response model 120, information about the context of the query, and so on. The sequence response model 120 can generate a first model response 308 based on the first prompt 306.

The first model response 308 can be used by the query response system to generate a user 102 to generate a user interface that includes the first model response. In some examples, the user interface also includes one or more user selectable elements that can request that the sequence response model 120 generate a simplified version of the first model response 308.

The query response system 102 can transmit the first model response along with any instructions for displaying response in a user interface to the user computing device 302. The user computer device 302 can display 310 the first model response 308 as well as any changes to the user interface determined by the query response system 102.

The user can, while viewing the first response, select a simplify button 312 from the user interface. In response, the user computing device 302 can generate a simplify request and transmit it to the query response system 102. The query response system can use the simplify request to generate a second prompt 316. The second prompt can include information describing the particular first model response 308 for which a simplified version is requested. The second prompt 316 can be provided to the sequence responsible one to zero. The secret response model 120 and generate the second model response 318.

The second model response 318 can be a simplified representation of the information included in the first model output. This information can be presented at a level of understanding more appropriate for the user. The second model response 318 can be partially based on information stored in a user profile and provided by the user. The second model response through it can be used to update the user interface instructions 320. The second model response and the updated user interface instructions can be transmitted to the user computer by 302. The user computing device 302 can update the interface and display the second model response to the user 322.

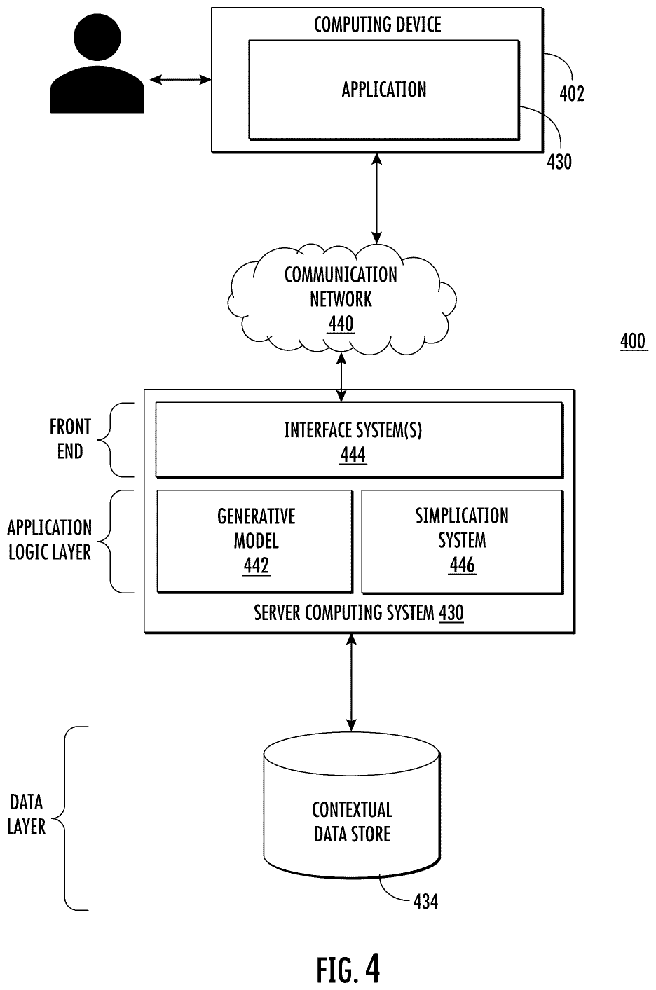

FIG. 4 depicts an example client-server environment 400 according to example embodiments of the present disclosure. The client-server system environment 400 includes one or more user computing devices 402 and a server computing system 430. One or more communication networks 220 can interconnect these components. The communication networks 4400 may be any of a variety of network types, including local area networks (LANs), wide area networks (WANs), wireless networks, wired networks, the Internet, personal area networks (PANs), or a combination of such networks.

A user computing device 402 can include, but is not limited to, smartphones, smartwatches, fitness bands, navigation computing devices, laptops computers, embedded computing devices (computing devices integrated into other objects such as clothing, vehicles, or other objects). In some examples, a user computing device 402 can include one or more sensors intended to gather information with the permission of the user associated with the user computing device 402.

A user computing device 402 can include one or more application(s) such as search applications, communication applications, navigation applications 130, productivity applications, game applications, word processing applications, or any other applications. The application(s) can include a web browser. The user computing device 100 can use a web browser (or other application) to send and receive requests to and from the server computing system 230. The application(s) can include a navigation application 130 that enables the user to send navigation requests to the server computing system 230 and receive navigation information in response.

As shown in FIG. 4, the server computing system 430 can generally be based on a three-tiered architecture, consisting of a front-end layer, application logic layer, and data layer. As is understood by skilled artisans in the relevant computer and Internet-related arts, each component shown in FIG. 4 can represent a set of executable software instructions and the corresponding hardware (e.g., memory and processor) for executing the instructions. To avoid unnecessary detail, various components and engines that are not germane to conveying an understanding of the various examples have been omitted from FIG. 4. However, a skilled artisan will readily recognize that various additional components and engines may be used with a server computing system 430, such as that illustrated in FIG. 4, to facilitate additional functionality that is not specifically described herein. Furthermore, the various components depicted in FIG. 4 may reside on a single server computer or may be distributed across several server computers in various arrangements. Moreover, although the server computing system 430 is depicted in FIG. 4 as having a three-tiered architecture, the various example embodiments are by no means limited to this architecture.

As shown in FIG. 4, the front end can consist of an interface system(s) 444, which receives communications from one or more user computing devices 402 and communicates appropriate responses to the user computing devices 402. For example, the interface system(s) 444 may receive requests in the form of Hypertext Transfer Protocol (HTTP) requests, or other web-based, application programming interface (API) requests. The user computing devices 402 may be executing conventional web browser applications or applications that have been developed for a specific platform to include any of a wide variety of computing devices and operating systems.

As shown in FIG. 4, the data layer can include a contextual data store 434. The contextual data store 434 can store a variety of contextual data. For example, the contextual data store 434 can include user profile data. In some examples, the user profile data can include data provided by users to personalize responses from the server computing system 430. User profiles can include user demographic data, user location data, user education data, history of past interactions with the user including previously received queries and previously generated response, and so on.

The contextual data store 434 can also include factual information on a plurality of topics. In some examples, the server computing system 430 can determine a topic associated with the user query. In response, the server computing system 430 can access factual information associated with the topic from the contextual data store 434.

The application logic layer can include application data that can provide a broad range of other applications and services that allow users to access or receive geographic data for navigation or other purposes. The application logic layer can include a generative model 442 and a simplification system 444.

The one or more generative models 442 can include language models (e.g., large language models and/or vision language models), image generation models (e.g., text-to-image generation models and/or image augmentation models), audio generation models, video generation models, graph generation models, and/or other data generation models (e.g., other content generation models). The one or more generative models 442 can include one or more transformer models, one or more convolutional neural networks, one or more recurrent neural networks, one or more feedforward neural networks, one or more generative adversarial networks, one or more self-attention models, one or more embedding models, one or more encoders, one or more decoders, and/or one or more other models. In some implementations, the one or more generative models 442 can include one or more autoregressive models (e.g., a machine-learned model trained to generate predictive values based on previous behavior data) and/or one or more diffusion models (e.g., a machine-learned model trained to generate predicted data based on generating and processing distribution data associated with the input data).

The one or more generative models 442 can be trained to process input data and generate model-generated content items, which may include a plurality of predicted words, pixels, signals, and/or other data. The model-generated content items may include novel content items that are not the same as any pre-existing work. The one or more generative models 442 can leverage learned representations, sequences, and/or probability distributions to generate the content items, which may include phrases, storylines, settings, objects, characters, beats, lyrics, and/or other aspects that are not included in pre-existing content items.

The simplification system 446 can be a system for receiving a simplification request from the computing device 4/2, and in response, generating the new prompt that requests the generative model 442 to generate an output that has been simplified. For example, the generative model 442 can receive a query and generate a response. That response can be displayed to a user. If the user determines that the response is too difficult, complicated, or complex to understand, the user can, through the user interface, request a simplified version of the response. The simplification system 446 can generate an updated prompt that includes specific instructions to simplify the response. In some examples, the instructions indicate the response should use simpler language to explain the concepts. In some examples, the prompt can include instructions indicating that the response can include analogies, stories, examples, and other techniques to make the content more easily understood.

In some examples, the simplification system 446 can access information from the contextual data store to generate the appropriate simplification prompt. For example, the contextual data store can include information about the user's language, education, background with a particular topic, previous queries, and so on. This information can be included in the simplification prompt to ensure that the generated simplified response is appropriate.

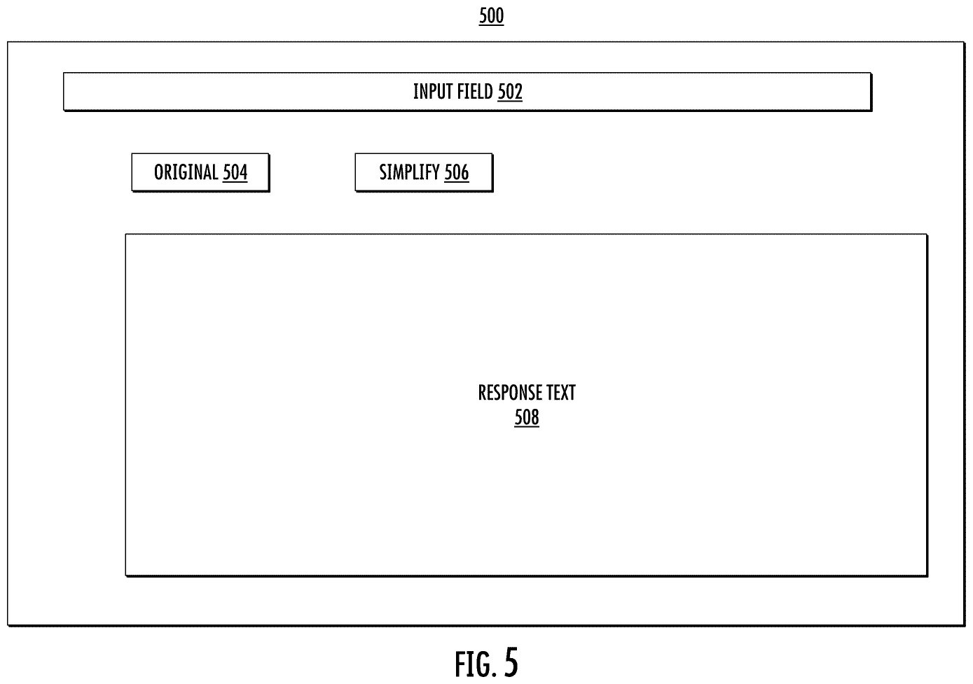

FIG. 5 depicts an example user interface for displaying model responses generated by a generative model according to example embodiments of the present disclosure. In this example, the user interface 500 includes several user interface elements. For example, the user interface can include an input field 502. The user can use that input field to input a user request or user query. Once the user has submitted the user query, the user query could be transmitted to a server computer system that stores a generative model.

In response to the user query, the generative model can generate a response. The response can be responsive to the user query. The response can be displayed in the response text 508 portion of the user interface. The user can review the response text 508. The original response can be viewed when the original user interface element 504 is selected. If the user does not understand the response text 508 fully, or wishes additional detail, the user can select the “simplify” user interface element 506.

If the “simplify” user interface element 506 is selected, the generative model can generate a simplified version of the response. This simplified version of the response can be displayed in the response text portion 508 of the interface 500. The user can select between the original response text and the simplified response text by selecting either the original user interface response by four or the simplified user interface response button 506.

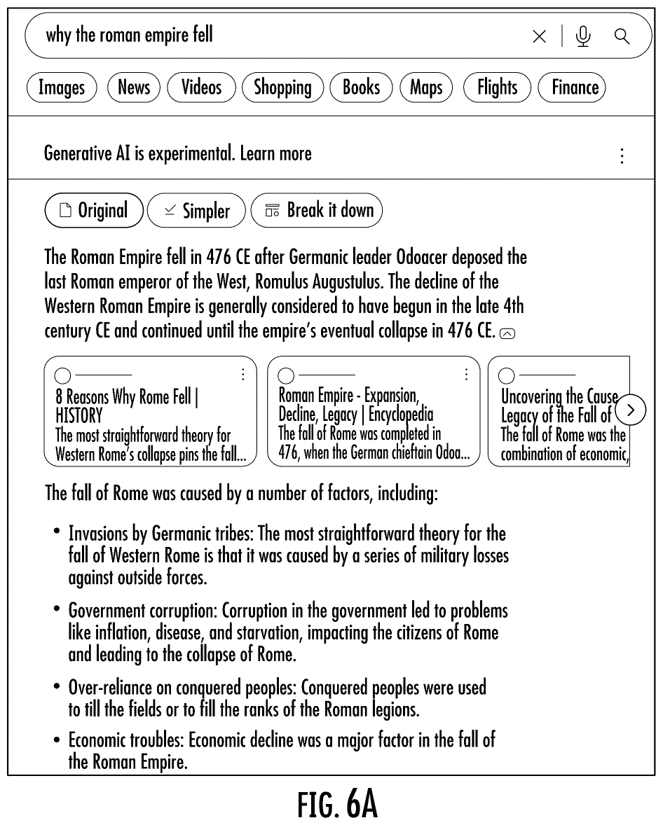

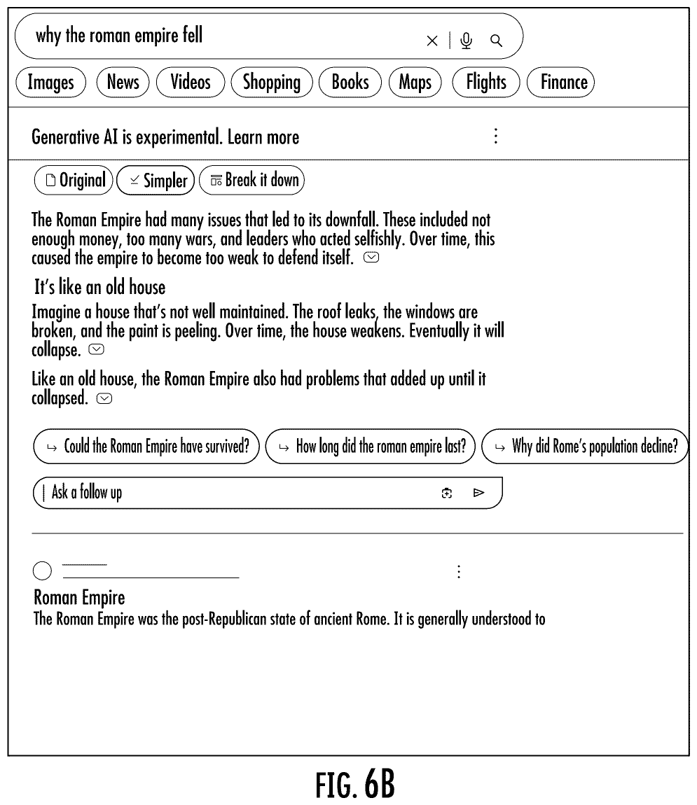

FIG. 6A depicts an example user interface for displaying model responses generated by a generative model according to example embodiments of the present disclosure. The user interface can include an input field as well as an area in which the response text is displayed. In this example, the user input was “why the Roman Empire fell.” The user interface includes an area for displaying the response text 608. The response text can include information associated with the fall of the Roman empire.

The user interface includes three different user selectable tabs. The tabs include the labels “Original,” “Simpler,” and “Break It Down.” The original response is displayed when the “Original” tab is selected.

FIG. 6B depicts an example user interface for displaying model responses generated by a generative model according to example embodiments of the present disclosure. In this example, the user has selected the “simpler” user interface tab. In response, the generative model can provide a simplified version of the response.

The user interface displayed the simplified version of the response. As seen in this example, the simplified example uses simpler language, elides unnecessary detail, and uses examples and analogies to explain the concepts in simpler language.

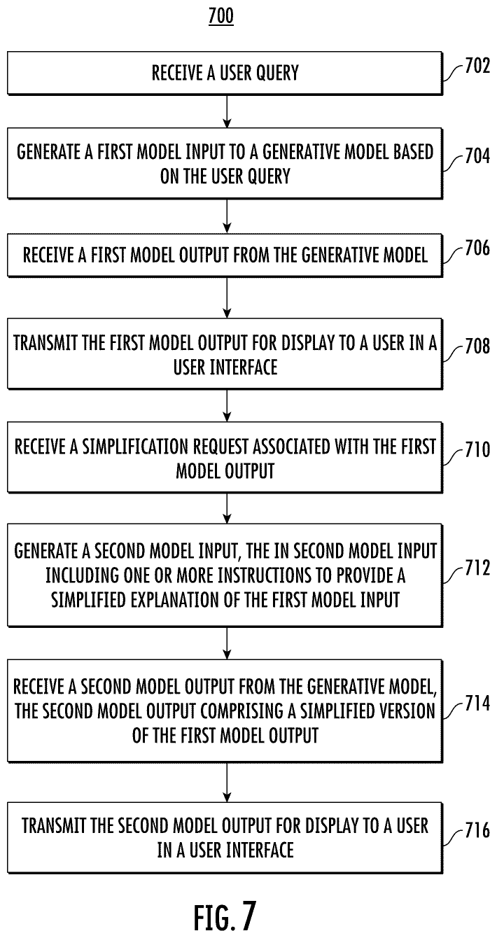

FIG. 7 depicts a flow chart diagram of an example method to perform according to example embodiments of the present disclosure. Although FIG. 7 depicts steps performed in a particular order for purposes of illustration and discussion, the methods of the present disclosure are not limited to the particularly illustrated order or arrangement. The various steps of the method 700 can be omitted, rearranged, combined, and/or adapted in various ways without deviating from the scope of the present disclosure.

In some examples, a computing system can, at 702, receive a user query. The computing system can, at 704, generate a first model input to a generative model based on the user query. In some examples, the first model input is a prompt. The first prompt can include the user query, instructions for generating the first model output, and contextual information. The contextual information can include user profile information.

The computing system can, at 706, receive a first model output from the generative model. The generative model can be a sequence processing model. The computing system can, at 708, transmit the first model output for display to a user in a user interface. In some examples, the computing system can determine that the user query is associated with education. In response to determining that the user query is associated with education, the computing system can transmit instructions to update the user interface to include a simplification user interface element. In some examples, a user can select the interface element associated with requesting simplification. In response, the computing system can generate a simplification request.

In some examples, the computing system can, at 710, receive a simplification request associated with the first model output. The computing system can, at 712, generate a second model input, the second model input including one or more instructions to provide a simplified explanation of the first model input. In some examples, the second prompt includes instructions to provide a simpler explanation of the first model output. The second prompt can include instructions to provide an explanation that includes one or more of analogies, stories, visual, and real-world examples.

In some examples, the computing system can, at 714, receive a second model output from the generative model, the second model output comprising a simplified version of the first model output. The computing system can, at 716, transmit the second model output for display to a user in a user interface. The computing system can update the user interface to replace the first model output with the second model output.

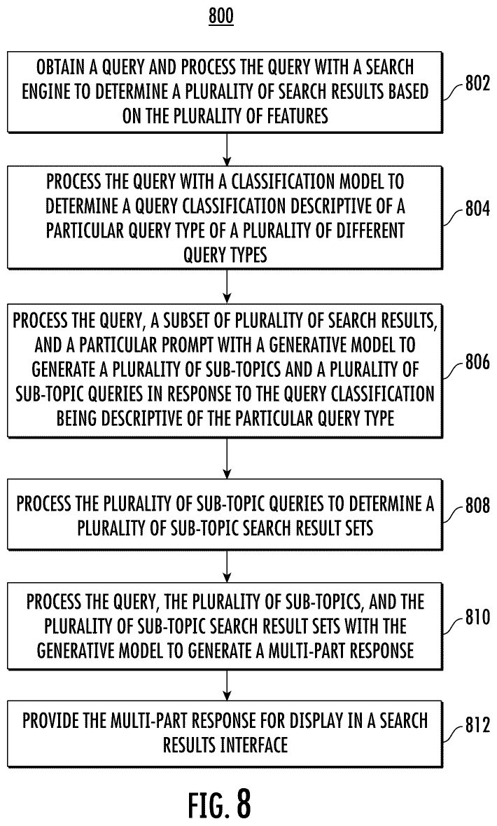

FIG. 8 depicts a flow chart diagram of an example method to perform according to example embodiments of the present disclosure. Although FIG. 8 depicts steps performed in a particular order for purposes of illustration and discussion, the methods of the present disclosure are not limited to the particularly illustrated order or arrangement. The various steps of the method 800 can be omitted, rearranged, combined, and/or adapted in various ways without deviating from the scope of the present disclosure.

At 802, a computing system can obtain a query and process the query with a search engine to determine a plurality of search results based on the plurality of features. The query can include a plurality of features. The query can include text data, image data, audio data, latent encoding data, multimodal data, and/or other data. The plurality of search results may be associated with a plurality of different content items, which may include text, images, videos, audio files, etc.

At 804, the computing system can process the query with a classification model to determine a query classification descriptive of a particular query type of a plurality of different query types. The classification model may be trained to determine whether a query is associated with a particular query type that may cause a user to request a model-generated response. Alternatively and/or additionally, the classification model may be trained to determine whether a query may be associated with an educational response, a multi-faceted response, and/or other complex responses.

In some implementations, the computing system can process the query with a first query classification model to determine a first query classification and may determine to provide the query to the classification model based on the first query classification. The computing system can provide the query and the subset of plurality of search results to the generative model based on the first query classification, process the query and the subset of plurality of search results with the generative model to generate a first model-generated response, and provide the first model-generated response for display within the search results interface. The first model-generated response can include a response to the query generated based on the content of the subset of plurality of search results.

At 806, the computing system can process the query, a subset of plurality of search results, and a particular prompt with a generative model to generate a plurality of sub-topics and a plurality of sub-topic queries in response to the query classification being descriptive of the particular query type. The plurality of sub-topics can be associated with a topic of information responsive to the query. In some implementations, the plurality of sub-topic queries can be associated with the plurality of sub-topics. The plurality of sub-topic queries can include a plurality of model-generated queries generated to obtain information associated with the plurality of sub-topics.

In some implementations, the computing system can provide a portion of the plurality of the search results for display with a selectable user interface element associated with preforming generative model processing before processing the query, the subset of the plurality of search results, and the particular prompt with the generative model to generate the plurality of sub-topics and the plurality of sub-topic queries. Additionally and/or alternatively, the computing system can obtain a selection of the selectable user interface element and provide the query, the subset of the plurality of search results, and the particular prompt to the generative model based on the selection.

At 808, the computing system can process the plurality of sub-topic queries to determine a plurality of sub-topic search result sets. Each of the plurality of sub-topic search result sets can be associated with a different sub-topic query of the plurality of sub-topic queries. In some implementations, the plurality of sub-topic search result sets can be determined based on one or more knowledge graphs.

At 810, the computing system can process the query, the plurality of sub-topics, and the plurality of sub-topic search result sets with the generative model to generate a multi-part response. The multi-part response can include a plurality of sub-topic headers and a plurality of sub-topic descriptions. Additionally and/or alternatively, the multi-part response may include stylized headers and description sections.

In some implementations, processing the query, the plurality of sub-topics, and the plurality of sub-topic search result sets with the generative model to generate the multi-part response can include generating an introduction and a conclusion including information responsive to the query, generating the plurality of sub-topic headers based on the plurality of sub-topics, generating the plurality of sub-topic descriptions based on the plurality of sub-topic search result sets, and generating the multi-part response. The multi-part response can include a structured format of the introduction, the plurality of sub-topic headers, the plurality of sub-topic descriptions, and the conclusion.

At 812, the computing system can provide the multi-part response for display in a search results interface. In some implementations, providing the multi-part response for display in the search results interface can include providing the multi-part response for display with a portion of the plurality of search results. The multi-part response can include the plurality of sub-topic headers are presented in bold. The plurality of sub-topic descriptions may be collapsable within the search results interface. Additionally and/or alternatively, each of the plurality of sub-topic descriptions can be presented with one or more respective search results from the plurality of sub-topic search result sets.

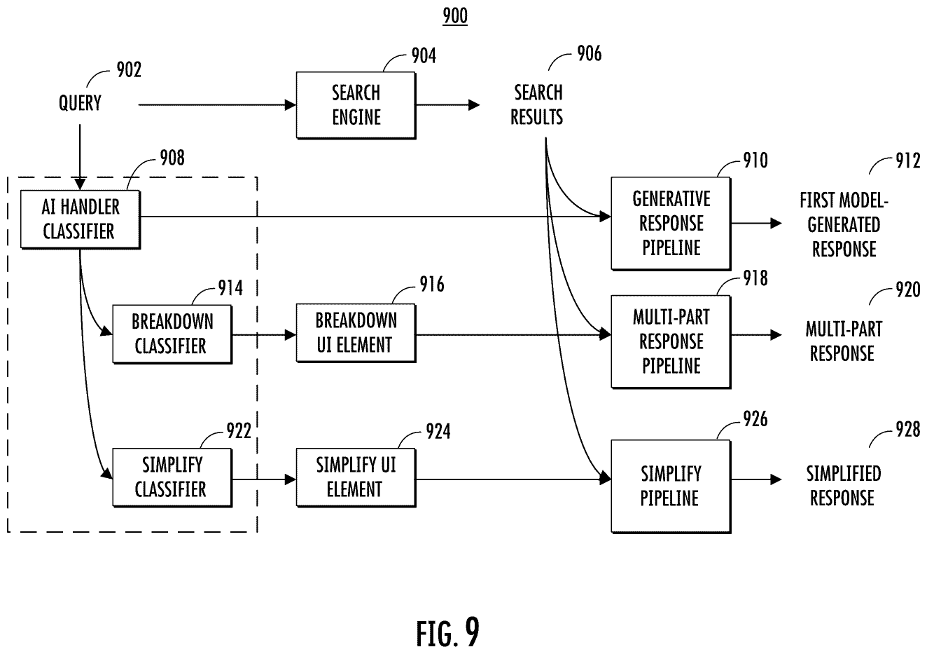

FIG. 9 depicts a block diagram of an example multi-pipeline system 900 according to example embodiments of the present disclosure. In particular, the multi-pipeline system 900 can obtain a query 902, determine a plurality of search results 906, and generate one or more model-generated responses (e.g., a first model-generated response 912, a multi-part response 920, and/or a simplified response 928).

For example, a query 902 can be obtained from a user. The query can be associated with a particular question, problem, and/or request. The query 902 may be associated with one or more topics.

A search engine 904 can process the query 902 to determine a plurality of search results 906 responsive to the query 902. The plurality of search results can include web resources associated with a particular topic of the query 902.

Additionally and/or alternatively, the query 902 can be processed with one or more classifiers to determine whether one or more artificial intelligence options are to be provided to the user to respond to the query 902. For example, the query 902 may be processed with an AI handler classifier 908 to determine whether a general model-generated response 912 is to be generated and/or provided via a generative response pipeline 910. The generative response pipeline 910 may be configured to process the query 902 and at least a subset of the plurality of search results 906 with a generative model to generate a natural language response to the query 902 based on information determined based on the search results 906.

If the query is one or more particular query types (e.g., educational, complex, historical, scientific, and/or one or more other selected query types), the query 902 may then be processed with a breakdown classifier 914 and/or a simplify classifier 922 to determine whether a breakdown option and/or a simplify option is to be provided to the user. Based on the output of the breakdown classifier 914, a selectable breakdown user interface element 916 may be provide for display, which when selected may cause the query 902 and at least a subset of the search results 906 to be processed with a multi-part response pipeline 918 to generate a multi-part response 920. Based on the output of the simplify classifier 922, a selectable simplify user interface element 924 may be provide for display, which when selected may cause the query 902 and at least a subset of the search results 906 to be processed with a simplify pipeline 926 to generate a simplified response 928.

The search results 906, the first model-generated response 912, the multi-part response 920, and/or the simplified response 928 may be provided for display in a search results interface, which may be updated as one or more user interface elements are selected.

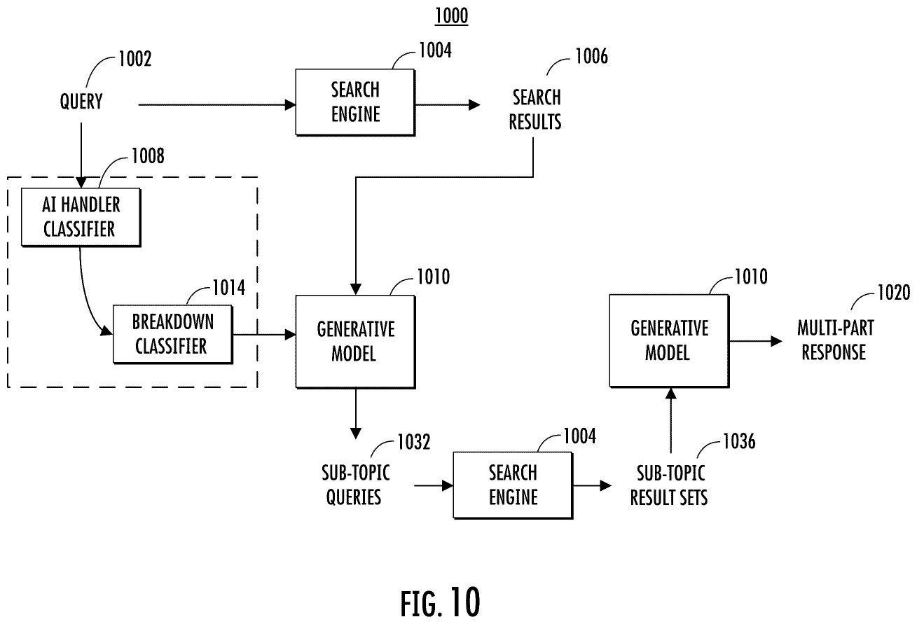

FIG. 10 depicts a block diagram of an example breakdown pipeline system 1000 according to example embodiments of the present disclosure. In particular, the breakdown pipeline system 1000 can obtain a query 1002, determine a plurality of search results 1006 responsive to the query 1002, and then generate a multi-part response 1020 to the query 1002.

For example, the breakdown pipeline system 1000 can obtain a query 1002 via a query input box of a search interface. The query 1002 can be processed with a search engine 1004 to determine a plurality of search results 1006 associated with the query 1002 (e.g., via an embedding based search, a keyword search, and/or other search techniques).

The breakdown pipeline system 1000 can process the query 1002 and/or the search results 1006 with one or more classifiers (e.g., an artificial intelligence (AI) handler classifier 1008 and/or a breakdown classifier 1014) to determine whether the query is associated with a particular query type that is a candidate for providing the breakdown feature (e.g., an option to leverage one or more machine-learned models and one or more search engines to generate a structured model-generated response to the query).

In response to determining the query 1002 is associated with a complex query type and/or complex response type, the breakdown pipeline system 1000 may perform multi-part response generation and/or provide a selectable option to the user to allow a user to select whether to perform the multi-part response generation.

The multi-part response generation can include processing the query 1002 and at least a subset of the search results 1006 with a generative model 1010 (e.g., a blueprint generation model) to generate a blueprint output. The blueprint output can include a plurality of sub-topics determined to be associated with a response to the query 1002 and a plurality of sub-topic queries 1032 generated to obtain additional information on the plurality of sub-topics.

A search engine 1004 and/or other information retrieval system may then process the plurality of sub-topic queries to determine a plurality of sub-topic result sets 1036 responsive to the plurality of sub-topic queries 1032. The query 1002, the blueprint output, and/or the plurality of sub-topic result sets 1036 can then be processed with a generative model 1010 (e.g., a response generation model) to generate the multi-part response 1020. The multi-part response 1020 can include an overview, introduction, and/or conclusion directly responsive to the query 1002, while also including a plurality of sub-topic sections with headers and descriptions that provide additional information on sub-topics associated with the answer to the query 1002. The additional information may be determined based on the content of the plurality of sub-topic result sets 1036.

In some implementations, the multi-part response 1020 can include text images, audio files, videos, and/or other model-generated data. The multi-part response 1020 may include embedded web resources associated with learning more on the one or more sub-topics. The multi-part response 1020 may include different structural and/or stylistic attributes to distinguish the differences between sections, headers, and/or content types.

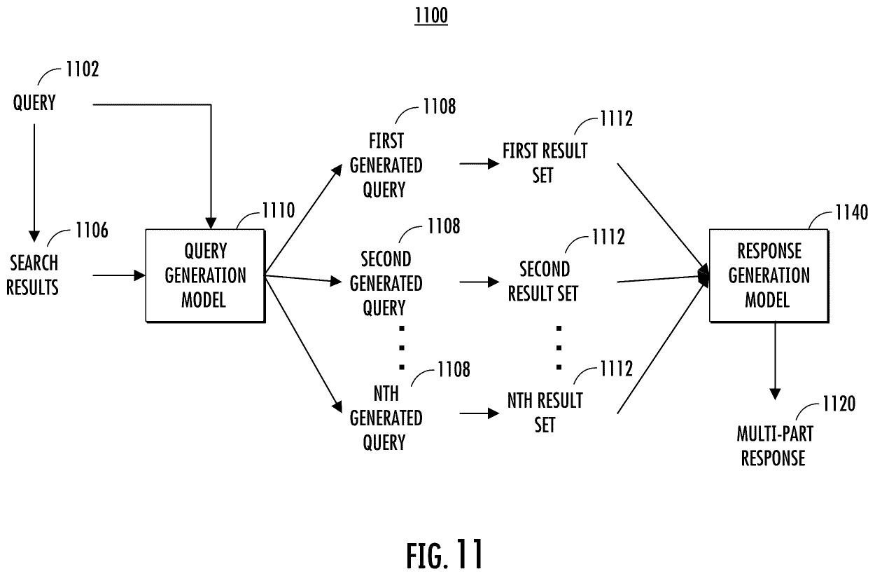

FIG. 11 depicts a block diagram of an example multi-part response generation system 1100 according to example embodiments of the present disclosure. In particular, the multi-part response generation system 1100 can obtain a query 1102, generate sub-topic queries 1108 based on determined sub-topics, obtaining additional information based on the model-generated sub-topic queries 1108, and generating the multi-part response 1120 based on the additional information and the query 1102.

For example, a query 1102 can be obtained and processed to determine a plurality of search results 1106 responsive to the query 1102. The query 1102 and/or the search results 1106 can be processed with a query generation model 1110 (e.g., a large language model fine-tuned for query generation and/or conditioned based on a query generation prompt) to determine sub-topics associated with the topic of the response to the query 1102 and to generate a plurality of model-generated sub-topic queries 1108 based on the determined sub-topics (e.g., a first generated query generated based on a first determined sub-topic, a second generated query generated based on a second determined sub-topic, . . . an nth generated query generated based on an nth determined sub-topic). The sub-topics may be determined based on a semantic understanding of the one or more content items of the one or more search results 1106.

One or more knowledge graphs, one or more search engines, and/or one or more knowledge databases can then be searched based on the plurality of model-generated sub-topic queries 1108 to determine a plurality of sub-topic result sets 1112 (e.g., a first result set may be determined based on the first generated query, a second result set may be determined based on the second generated query, . . . , an nth result set may be determined based on the nth generated query).

The query 1102, the search results 1106, the determined sub-topics, and/or the plurality of sub-topic result sets 1112 can then be processed with a response generation model 1140 (e.g., a large language model fine-tuned for response generation and/or conditioned based on a response generation prompt) to generate the multi-part response 1120. The multi-part response 1120 may include an introduction and conclusion generated based on information obtained from the initial search results 1106 and a plurality of sub-topic sections generated based on information obtained from the plurality of sub-topic result sets 1112.

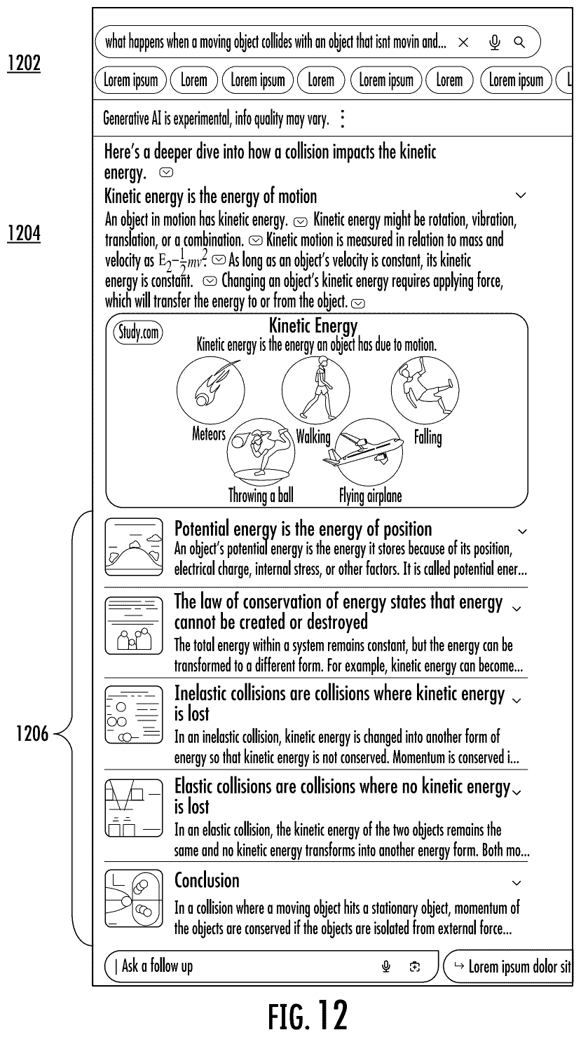

FIG. 12 depicts an illustration of an example multi-part response according to example embodiments of the present disclosure. In particular, FIG. 12 depicts an example multi-part response that is responsive to the query 1202. The multipart response can include a model-generated response overview 1204 and a plurality of expandable model-generated sub-topic content items 1206. The model-generated response overview 1204 can be generated by processing the query 1202 and a plurality of search results to generate a model-generated response to the query 1202 by determining information within the search results that are responsive to the query and then generating a response based on the identified information. The plurality of expandable model-generated sub-topic content items 1206 can include a plurality of sub-topic headers, a plurality of sub-topic descriptions, a plurality of sub-topic images, and/or a plurality of sub-topic web resources.

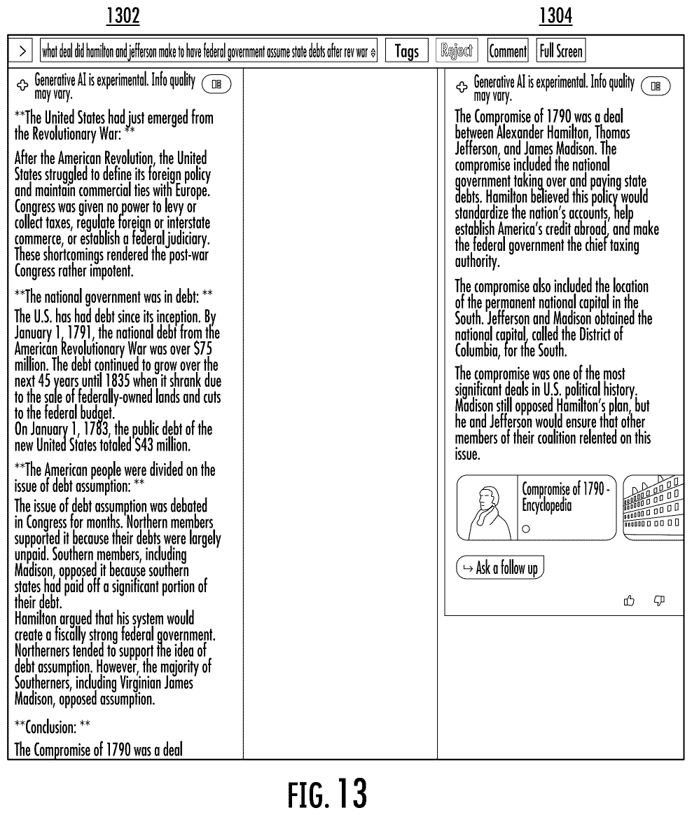

FIG. 13 depicts an illustration of example model-generated responses according to example embodiments of the present disclosure. In particular, FIG. 13 depicts an example structured multipart response 1302 and an example general model-generated response 1304 directed to responding to the same query. In some implementations, the example general model-generated response 1304 may be provided first, and the example structured multipart response 1302 may be generated and provided for display in response to selection of a breakdown option. The example structured multipart response 1302 can include an introduction, a conclusion, section headers, and/or section descriptions.

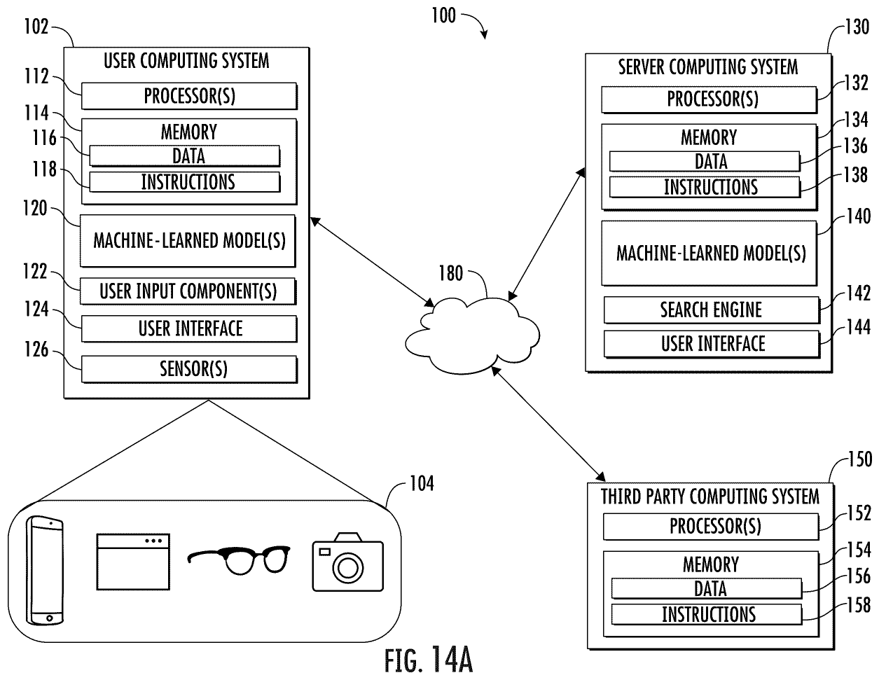

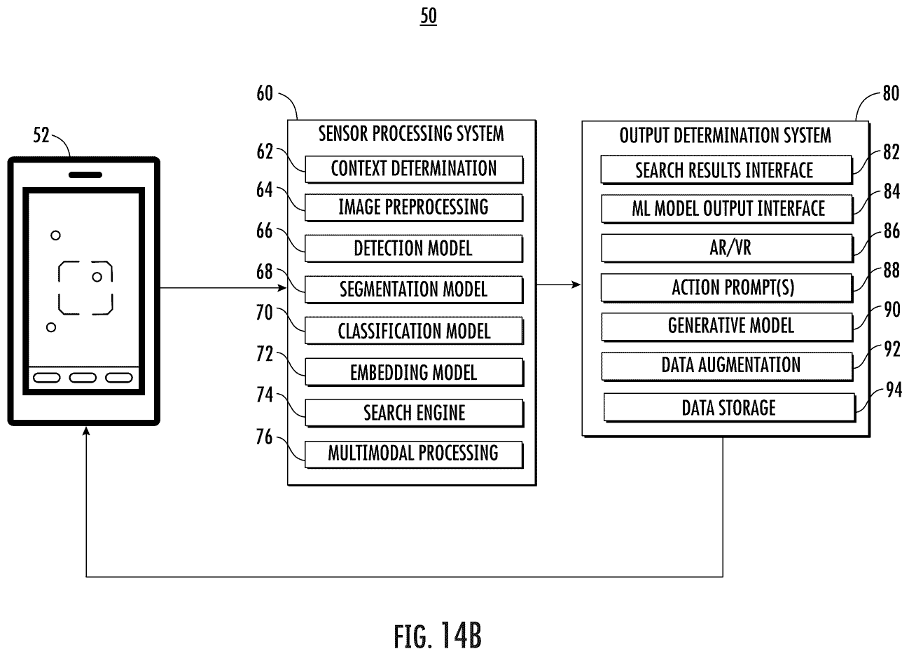

FIG. 14A depicts a block diagram of an example computing system 100 that performs search result processing according to example embodiments of the present disclosure. The system 100 includes a user computing system 102, a server computing system 130, and/or a third computing system 150 that are communicatively coupled over a network 180.

The user computing system 102 can include any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing system 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage mediums, such as RAM, ROM, EEPROM, EPROM, flash memory devices, magnetic disks, etc., and combinations thereof. The memory 114 can store data 116 and instructions 118 which are executed by the processor 112 to cause the user computing system 102 to perform operations.

In some implementations, the user computing system 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks.

In some implementations, the one or more machine-learned models 120 can be received from the server computing system 130 over network 180, stored in the user computing device memory 114, and then used or otherwise implemented by the one or more processors 112. In some implementations, the user computing system 102 can implement multiple parallel instances of a single machine-learned model 120 (e.g., to perform parallel machine-learned model processing across multiple instances of input data and/or detected features).

More particularly, the one or more machine-learned models 120 may include one or more detection models, one or more classification models, one or more segmentation models, one or more augmentation models, one or more generative models, one or more natural language processing models, one or more optical character recognition models, and/or one or more other machine-learned models. The one or more machine-learned models 120 can include one or more transformer models. The one or more machine-learned models 120 may include one or more neural radiance field models, one or more diffusion models, and/or one or more autoregressive language models.

The one or more machine-learned models 120 may be utilized to detect one or more object features. The detected object features may be classified and/or embedded. The classification and/or the embedding may then be utilized to perform a search to determine one or more search results. Alternatively and/or additionally, the one or more detected features may be utilized to determine an indicator (e.g., a user interface element that indicates a detected feature) is to be provided to indicate a feature has been detected. The user may then select the indicator to cause a feature classification, embedding, and/or search to be performed. In some implementations, the classification, the embedding, and/or the searching can be performed before the indicator is selected.

In some implementations, the one or more machine-learned models 120 can process image data, text data, audio data, and/or latent encoding data to generate output data that can include image data, text data, audio data, and/or latent encoding data. The one or more machine-learned models 120 may perform optical character recognition, natural language processing, image classification, object classification, text classification, audio classification, context determination, action prediction, image correction, image augmentation, text augmentation, sentiment analysis, object detection, error detection, inpainting, video stabilization, audio correction, audio augmentation, and/or data segmentation (e.g., mask based segmentation).

Machine-learned model(s) can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) can include a single or multiple instances of the same model configured to operate on data from input(s). Machine-learned model(s) can include an ensemble of different models that can cooperatively interact to process data from input(s). For example, machine-learned model(s) can employ a mixture-of-experts structure. See, e.g., Zhou et al., Mixture-of-Experts with Expert Choice Routing, ARXIV: 2202.09368v2 (Oct. 14, 2022).

Input(s) can generally include or otherwise represent various types of data. Input(s) can include one type or many different types of data. Output(s) can be data of the same type(s) or of different types of data as compared to input(s). Output(s) can include one type or many different types of data.

Example data types for input(s) or output(s) include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs or outputs, example combinations of data types include image data and audio data, image data and natural language data, natural language data and software code data, image data and biometric data, sensor data and medical data, etc. It is to be understood that any combination of data types in an input or an output can be present.

An example input can include one or multiple data types, such as the example data types noted above. An example output can include one or multiple data types, such as the example data types noted above. The data type(s) of input can be the same as or different from the data type(s) of output. It is to be understood that the example data types noted above are provided for illustrative purposes only. Data types contemplated within the scope of the present disclosure are not limited to those examples noted above.

Additionally or alternatively, one or more machine-learned models 140 can be included in or otherwise stored and implemented by the server computing system 130 that communicates with the user computing system 102 according to a client-server relationship. For example, the machine-learned models 140 can be implemented by the server computing system 130 as a portion of a web service (e.g., a viewfinder service, a visual search service, an image processing service, an ambient computing service, and/or an overlay application service). Thus, one or more models 120 can be stored and implemented at the user computing system 102 and/or one or more models 140 can be stored and implemented at the server computing system 130.

The user computing system 102 can also include one or more user input component 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

In some implementations, the user computing system 102 can store and/or provide one or more user interfaces 124, which may be associated with one or more applications. The one or more user interfaces 124 can be configured to receive inputs and/or provide data for display (e.g., image data, text data, audio data, one or more user interface elements, an augmented-reality experience, a virtual reality experience, and/or other data for display. The user interface 124 may be associated with one or more other computing systems (e.g., server computing system 130 and/or third party computing system 150). The user interfaces 124 can include a viewfinder interface, a search interface, a generative model interface, a social media interface, and/or a media content gallery interface.

The user computing system 102 may include and/or receive data from one or more sensors 126. The one or more sensors 126 may be housed in a housing component that houses the one or more processors 112, the memory 114, and/or one or more hardware components, which may store, and/or cause to perform, one or more software packets. The one or more sensors 126 can include one or more image sensors (e.g., a camera), one or more lidar sensors, one or more audio sensors (e.g., a microphone), one or more inertial sensors (e.g., inertial measurement unit), one or more biological sensors (e.g., a heart rate sensor, a pulse sensor, a retinal sensor, and/or a fingerprint sensor), one or more infrared sensors, one or more location sensors (e.g., GPS), one or more touch sensors (e.g., a conductive touch sensor and/or a mechanical touch sensor), and/or one or more other sensors. The one or more sensors can be utilized to obtain data associated with a user's environment (e.g., an image of a user's environment, a recording of the environment, and/or the location of the user).

The user computing system 102 may include, and/or be part of, a user computing device 104. The user computing device 104 may include a mobile computing device (e.g., a smartphone or tablet), a desktop computer, a laptop computer, a smart wearable, and/or a smart appliance. Additionally and/or alternatively, the user computing system may obtain from, and/or generate data with, the one or more one or more user computing devices 104. For example, a camera of a smartphone may be utilized to capture image data descriptive of the environment, and/or an overlay application of the user computing device 104 can be utilized to track and/or process the data being provided to the user. Similarly, one or more sensors associated with a smart wearable may be utilized to obtain data about a user and/or about a user's environment (e.g., image data can be obtained with a camera housed in a user's smart glasses). Additionally and/or alternatively, the data may be obtained and uploaded from other user devices that may be specialized for data obtainment or generation.

The server computing system 130 includes one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more non-transitory computer-readable storage mediums, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Example models 140 are discussed with reference to FIG. 9B.

Additionally and/or alternatively, the server computing system 130 can include and/or be communicatively connected with a search engine 142 that may be utilized to crawl one or more databases (and/or resources). The search engine 142 can process data from the user computing system 102, the server computing system 130, and/or the third party computing system 150 to determine one or more search results associated with the input data. The search engine 142 may perform term based search, label based search, Boolean based searches, image search, embedding based search (e.g., nearest neighbor search), multimodal search, and/or one or more other search techniques.

The server computing system 130 may store and/or provide one or more user interfaces 144 for obtaining input data and/or providing output data to one or more users. The one or more user interfaces 144 can include one or more user interface elements, which may include input fields, navigation tools, content chips, selectable tiles, widgets, data display carousels, dynamic animation, informational pop-ups, image augmentations, text-to-speech, speech-to-text, augmented-reality, virtual-reality, feedback loops, and/or other interface elements.

The user computing system 102 and/or the server computing system 130 can train the models 120 and/or 140 via interaction with the third party computing system 150 that is communicatively coupled over the network 180. The third party computing system 150 can be separate from the server computing system 130 or can be a portion of the server computing system 130. Alternatively and/or additionally, the third party computing system 150 may be associated with one or more web resources, one or more web platforms, one or more other users, and/or one or more contexts.

An example machine-learned model can include a generative model (e.g., a large language model, a foundation model, a vision language model, an image generation model, a text-to-image model, an audio generation model, and/or other generative models).

Training and/or tuning the machine-learned model can include obtaining a training instance. A set of training data can include a plurality of training instances divided between multiple datasets (e.g., a training dataset, a validation dataset, or testing dataset). A training instance can be labeled or unlabeled. The runtime inferences can form training instances when a model is trained using an evaluation of the model's performance on that runtime instance (e.g., online training/learning). Example data types for the training instance and various tasks associated therewith are described throughout the present disclosure.

Training and/or tuning can include processing, using one or more machine-learned models, the training instance to generate an output. The output can be directly obtained from the one or more machine-learned models or can be a downstream result of a chain of processing operations that includes an output of the one or more machine-learned models.

Training and/or tuning can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

Training and/or tuning can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Training and/or tuning can include implementing a number of generalization techniques (e.g., weight decays, dropouts, etc.) to improve the generalization capability of the models being trained.

In some implementations, the above training loop can be implemented for training a machine-learned model from an initialized state to a fully trained state (e.g., when the model exhibits a desired performance profile, such as based on accuracy, precision, recall, etc.).

In some implementations, the above training loop can be implemented for particular stages of a training procedure. For instance, in some implementations, the above training loop can be implemented for pre-training a machine-learned model. Pre-training can include, for instance, large-scale training over potentially noisy data to achieve a broad base of performance levels across a variety of tasks/data types. In some implementations, the above training loop can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

In some implementations, the computing system 100 may utilize one or more soft prompts for conditioning the one or more machine-learned models (120 and/or 140) for downstream tasks. The one or more soft prompts can include a set of tunable parameters that can be trained (or tuned) as the parameters of the one or more machine-learned models (120 and/or 140) are fixed. The one or more soft prompts 124 can be trained for a specific task and/or a specific set of tasks. Alternatively and/or additionally, the one or more soft prompts 124 may be trained to condition the one or more machine-learned models (120 and/or 140) to perform inferences for a particular individual, one or more entities, and/or one or more tasks such that the output is tailored for that particular individual, particular entities, and/or particular task. The one or more soft prompts 124 can be obtained and processed with one or more inputs by the one or more machine-learned models (120 and/or 140).

The one or more soft prompts can include a set of machine-learned weights. In particular, the one or more soft prompts can include weights that were trained to condition a generative model to generate model-generated content with one or more particular attributes. For example, the one or more soft prompts can be utilized by a user to generate content based on the fine-tuning. The one or more soft prompts can be extended to a plurality of tasks. For example, the computing system 100 may tune the set of parameters on a plurality of different content attributes and/or types. The one or more soft prompts may include a plurality of learned vector representations that may be model-readable.

A particular soft prompt can be obtained based on a particular task, individual, content type, etc. The particular soft prompt can include a set of learned parameters. The set of learned parameters can be processed with the generative model to generate the model-generated image.

The user computing system 102 and/or the server computing system 130 may store one or more soft prompts associated with the particular user and/or particular task. The soft prompt(s) can include a set of parameters. The user computing system 102 and/or the server computing system 130 may leverage the set of parameters of the soft prompt(s) and a generative model to generate a model-generated content item. In some implementations, the model-generated content item can be generated based on the set of parameters associated with the particular individual and/or task.

The utilization of a soft prompt (i.e., a set of parameters that can be processed with a generative model for downstream task conditioning) can reduce the computational cost for parameter tuning for object-specific content generation by reducing the parameters to be tuned. The set of parameters can be limited and may be adjusted while the parameters of the pre-trained generative model stay fixed. The set of parameters of the soft prompt can be utilized to condition the pre-trained generative model (e.g., the machine-learned image generation model and/or language model) for particular downstream tasks (e.g., response generation and/or image rendering).

In some implementations, the generative language model and/or one or more soft prompts (e.g., a set of machine-learned parameters that can be processed with the input by the generative language model) can be trained to generate content with particular attributes.

In some implementations, the server computing system 130 can include a prompt library. The prompt library can store a plurality of prompt templates (e.g., a plurality of hard prompt templates (e.g., text prompt templates)) and/or a plurality of soft prompts. The plurality of prompt templates can include hard prompt templates (e.g., text string data) that may be combined with the user input to generate a more detailed and complete prompt for the generative model to process. The templates can include text descriptive of the request. The templates may be object-specific, user-specific, and/or content-specific. The plurality of prompt templates may include few-shot examples.

The prompt library can store a plurality of soft prompts. The plurality of soft prompts may be associated with a plurality of different content attributes and/or a plurality of different individuals. The plurality of soft prompts can include learned parameters and/or learned weights that can be processed with the generative model to condition the generative model to generate content items with particular attributes. The plurality of soft prompts may have been tuned by freezing the parameters of a pre-trained generative model, while the parameters of the soft prompt are learned based on a particular task and/or user. The plurality of soft prompts can include a plurality of different soft prompts associated with a plurality of different users and/or a plurality of different sets of users.

The third party computing system 150 can include one or more processors 152 and a memory 154. The one or more processors 152 can be any suitable processing device (e.g., a processor core, a microprocessor, an ASIC, a FPGA, a controller, a microcontroller, etc.) and can be one processor or a plurality of processors that are operatively connected. The memory 154 can include one or more non-transitory computer-readable storage mediums, such as RAM, ROM, EEPROM, EPROM, flash memory devices, magnetic disks, etc., and combinations thereof. The memory 154 can store data 156 and instructions 158 which are executed by the processor 152 to cause the third party computing system 150 to perform operations. In some implementations, the third party computing system 150 includes or is otherwise implemented by one or more server computing devices.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, the task can be a generative task, and the one or more machine-learned models (e.g., 120 and/or 140) can be configured to output content generated in view of one or more inputs. For instance, the inputs can be or otherwise represent data of one or more modalities that encodes context for generating additional content.

In some implementations, the task can be a text completion task. The machine-learned models can be configured to process the inputs that represent textual data and to generate the outputs that represent additional textual data that completes a textual sequence that includes the inputs. For instance, the machine-learned models can be configured to generate the outputs to complete a sentence, paragraph, or portion of text that follows from a portion of text represented by inputs.

In some implementations, the task can be an instruction following task. The machine-learned models can be configured to process the inputs that represent instructions to perform a function and to generate the outputs that advance a goal of satisfying the instruction function (e.g., at least a step of a multi-step procedure to perform the function). The outputs can represent data of the same or of a different modality as the inputs. For instance, the inputs can represent textual data (e.g., natural language instructions for a task to be performed) and the machine-learned models can process the inputs to generate the outputs that represent textual data responsive to the instructions (e.g., natural language responses, programming language responses, machine language responses, etc.). The inputs can represent image data (e.g., image-based instructions for a task to be performed, optionally accompanied by textual instructions) and the machine-learned models can process the inputs to generate the outputs that represent textual data responsive to the instructions (e.g., natural language responses, programming language responses, machine language responses, etc.). One or more outputs can be iteratively or recursively generated to sequentially process and accomplish steps toward accomplishing the requested functionality. For instance, an initial output can be executed by an external system or be processed by the machine-learned models to complete an initial step of performing a function. Multiple steps can be performed, with a final output being obtained that is responsive to the initial instructions.

In some implementations, the task can be a question answering task. The machine-learned models can be configured to process the inputs that represent a question to answer and to generate the outputs that advance a goal of returning an answer to the question (e.g., at least a step of a multi-step procedure to perform the function). The outputs can represent data of the same or of a different modality as the inputs. For instance, the inputs can represent textual data (e.g., natural language instructions for a task to be performed) and the machine-learned models can process the inputs to generate the outputs that represent textual data responsive to the question (e.g., natural language responses, programming language responses, machine language responses, etc.). The inputs can represent image data (e.g., image-based instructions for a task to be performed, optionally accompanied by textual instructions) and the machine-learned models can process the inputs to generate the outputs that represent textual data responsive to the question (e.g., natural language responses, programming language responses, machine language responses, etc.). One or more outputs can be iteratively or recursively generated to sequentially process and accomplish steps toward answering the question. For instance, an initial output can be executed by an external system or be processed by the machine-learned models to complete an initial step of obtaining an answer to the question (e.g., querying a database, performing a computation, executing a script, etc.). Multiple steps can be performed, with a final output being obtained that is responsive to the question.

In some implementations, the task can be an image generation task. The machine-learned models can be configured to process the inputs that represent context regarding a desired portion of image content. The context can include text data, image data, audio data, etc. Machine-learned models can be configured to generate the outputs that represent image data that depicts imagery related to the context. For instance, the machine-learned models can be configured to generate pixel data of an image. Values for channels associated with the pixels in the pixel data can be selected based on the context (e.g., based on a probability determined based on the context).

In some implementations, the task can be an audio generation task. Machine-learned models can be configured to process the inputs that represent context regarding a desired portion of audio content. The context can include text data, image data, audio data, etc. The machine-learned models can be configured to generate the outputs that represent audio data related to the context. For instance, the machine-learned models can be configured to generate waveform data in the form of an image (e.g., a spectrogram). Values for channels associated with pixels of the image can be selected based on the context. The machine-learned models can be configured to generate waveform data in the form of a sequence of discrete samples of a continuous waveform. Values of the sequence can be selected based on the context (e.g., based on a probability determined based on the context).

In some implementations, the task can be a data generation task. Machine-learned models can be configured to process the inputs that represent context regarding a desired portion of data (e.g., data from various data domains, such as sensor data, image data, multimodal data, statistical data, etc.). The desired data can be, for instance, synthetic data for training other machine-learned models. The context can include arbitrary data types. The machine-learned models can be configured to generate the outputs that represent data that aligns with the desired data. For instance, the machine-learned models can be configured to generate data values for populating a dataset. Values for the data objects can be selected based on the context (e.g., based on a probability determined based on the context).

The user computing system may include a number of applications (e.g., applications 1 through N). Each application may include its own respective machine learning library and machine-learned model(s). For example, each application can include a machine-learned model. Example applications include a text messaging application, an email application, a dictation application, a virtual keyboard application, a browser application, etc.

Each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

The user computing system 102 can include a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing system 100.

The central intelligence layer can communicate with a central device data layer. The central device data layer can be a centralized repository of data for the computing system 100. The central device data layer may communicate with a number of other components of the computing device, such as, for example, one or more sensors, a context manager, a device state component, and/or additional components. In some implementations, the central device data layer can communicate with each device component using an API (e.g., a private API).

FIG. 14B depicts a block diagram of an example computing system 50 that performs search result processing according to example embodiments of the present disclosure. In particular, the example computing system 50 can include one or more computing devices 52 that can be utilized to obtain, and/or generate, one or more datasets that can be processed by a sensor processing system 60 and/or an output determination system 80 to feedback to a user that can provide information on features in the one or more obtained datasets. The one or more datasets can include image data, text data, audio data, multimodal data, latent encoding data, etc. The one or more datasets may be obtained via one or more sensors associated with the one or more computing devices 52 (e.g., one or more sensors in the computing device 52). Additionally and/or alternatively, the one or more datasets can be stored data and/or retrieved data (e.g., data retrieved from a web resource). For example, images, text, and/or other content items may be interacted with by a user. The interacted with content items can then be utilized to generate one or more determinations.

The one or more computing devices 52 can obtain, and/or generate, one or more datasets based on image capture, sensor tracking, data storage retrieval, content download (e.g., downloading an image or other content item via the internet from a web resource), and/or via one or more other techniques. The one or more datasets can be processed with a sensor processing system 60. The sensor processing system 60 may perform one or more processing techniques using one or more machine-learned models, one or more search engines, and/or one or more other processing techniques. The one or more processing techniques can be performed in any combination and/or individually. The one or more processing techniques can be performed in series and/or in parallel. In particular, the one or more datasets can be processed with a context determination block 62, which may determine a context associated with one or more content items. The context determination block 62 may identify and/or process metadata, user profile data (e.g., preferences, user search history, user browsing history, user purchase history, and/or user input data), previous interaction data, global trend data, location data, time data, and/or other data to determine a particular context associated with the user. The context can be associated with an event, a determined trend, a particular action, a particular type of data, a particular environment, and/or another context associated with the user and/or the retrieved or obtained data.

The sensor processing system 60 may include an image preprocessing block 64. The image preprocessing block 64 may be utilized to adjust one or more values of an obtained and/or received image to prepare the image to be processed by one or more machine-learned models and/or one or more search engines 74. The image preprocessing block 64 may resize the image, adjust saturation values, adjust resolution, strip and/or add metadata, and/or perform one or more other operations.

In some implementations, the sensor processing system 60 can include one or more machine-learned models, which may include a detection model 66, a segmentation model 68, a classification model 70, an embedding model 72, and/or one or more other machine-learned models. For example, the sensor processing system 60 may include one or more detection models 66 that can be utilized to detect particular features in the processed dataset. In particular, one or more images can be processed with the one or more detection models 66 to generate one or more bounding boxes associated with detected features in the one or more images.

Additionally and/or alternatively, one or more segmentation models 68 can be utilized to segment one or more portions of the dataset from the one or more datasets. For example, the one or more segmentation models 68 may utilize one or more segmentation masks (e.g., one or more segmentation masks manually generated and/or generated based on the one or more bounding boxes) to segment a portion of an image, a portion of an audio file, and/or a portion of text. The segmentation may include isolating one or more detected objects and/or removing one or more detected objects from an image.

The one or more classification models 70 can be utilized to process image data, text data, audio data, latent encoding data, multimodal data, and/or other data to generate one or more classifications. The one or more classification models 70 can include one or more image classification models, one or more object classification models, one or more text classification models, one or more audio classification models, and/or one or more other classification models. The one or more classification models 70 can process data to determine one or more classifications.

In some implementations, data may be processed with one or more embedding models 72 to generate one or more embeddings. For example, one or more images can be processed with the one or more embedding models 72 to generate one or more image embeddings in an embedding space. The one or more image embeddings may be associated with one or more image features of the one or more images. In some implementations, the one or more embedding models 72 may be configured to process multimodal data to generate multimodal embeddings. The one or more embeddings can be utilized for classification, search, and/or learning embedding space distributions.

The sensor processing system 60 may include one or more search engines 74 that can be utilized to perform one or more searches. The one or more search engines 74 may crawl one or more databases (e.g., one or more local databases, one or more global databases, one or more private databases, one or more public databases, one or more specialized databases, and/or one or more general databases) to determine one or more search results. The one or more search engines 74 may perform feature matching, text based search, embedding based search (e.g., k-nearest neighbor search), metadata based search, multimodal search, web resource search, image search, text search, and/or application search.

Additionally and/or alternatively, the sensor processing system 60 may include one or more multimodal processing blocks 76, which can be utilized to aid in the processing of multimodal data. The one or more multimodal processing blocks 76 may include generating a multimodal query and/or a multimodal embedding to be processed by one or more machine-learned models and/or one or more search engines 74.

The output(s) of the sensor processing system 60 can then be processed with an output determination system 80 to determine one or more outputs to provide to a user. The output determination system 80 may include heuristic based determinations, machine-learned model based determinations, user selection based determinations, and/or context based determinations.

The output determination system 80 may determine how and/or where to provide the one or more search results in a search results interface 82. Additionally and/or alternatively, the output determination system 80 may determine how and/or where to provide the one or more machine-learned model outputs in a machine-learned model output interface 84. In some implementations, the one or more search results and/or the one or more machine-learned model outputs may be provided for display via one or more user interface elements. The one or more user interface elements may be overlayed over displayed data. For example, one or more detection indicators may be overlayed over detected objects in a viewfinder. The one or more user interface elements may be selectable to perform one or more additional searches and/or one or more additional machine-learned model processes. In some implementations, the user interface elements may be provided as specialized user interface elements for specific applications and/or may be provided uniformly across different applications. The one or more user interface elements can include pop-up displays, interface overlays, interface tiles and/or chips, carousel interfaces, audio feedback, animations, interactive widgets, and/or other user interface elements.

Additionally and/or alternatively, data associated with the output(s) of the sensor processing system 60 may be utilized to generate and/or provide an augmented-reality experience and/or a virtual-reality experience 86. For example, the one or more obtained datasets may be processed to generate one or more augmented-reality rendering assets and/or one or more virtual-reality rendering assets, which can then be utilized to provide an augmented-reality experience and/or a virtual-reality experience 86 to a user. The augmented-reality experience may render information associated with an environment into the respective environment. Alternatively and/or additionally, objects related to the processed dataset(s) may be rendered into the user environment and/or a virtual environment. Rendering dataset generation may include training one or more neural radiance field models to learn a three-dimensional representation for one or more objects.

In some implementations, one or more action prompts 88 may be determined based on the output(s) of the sensor processing system 60. For example, a search prompt, a purchase prompt, a generate prompt, a reservation prompt, a call prompt, a redirect prompt, and/or one or more other prompts may be determined to be associated with the output(s) of the sensor processing system 60. The one or more action prompts 88 may then be provided to the user via one or more selectable user interface elements. In response to a selection of the one or more selectable user interface elements, a respective action of the respective action prompt may be performed (e.g., a search may be performed, a purchase application programming interface may be utilized, and/or another application may be opened).

In some implementations, the one or more datasets and/or the output(s) of the sensor processing system 60 may be processed with one or more generative models 90 to generate a model-generated content item that can then be provided to a user. The generation may be prompted based on a user selection and/or may be automatically performed (e.g., automatically performed based on one or more conditions, which may be associated with a threshold amount of search results not being identified).

The one or more generative models 90 can include language models (e.g., large language models and/or vision language models), image generation models (e.g., text-to-image generation models and/or image augmentation models), audio generation models, video generation models, graph generation models, and/or other data generation models (e.g., other content generation models). The one or more generative models 90 can include one or more transformer models, one or more convolutional neural networks, one or more recurrent neural networks, one or more feedforward neural networks, one or more generative adversarial networks, one or more self-attention models, one or more embedding models, one or more encoders, one or more decoders, and/or one or more other models. In some implementations, the one or more generative models 90 can include one or more autoregressive models (e.g., a machine-learned model trained to generate predictive values based on previous behavior data) and/or one or more diffusion models (e.g., a machine-learned model trained to generate predicted data based on generating and processing distribution data associated with the input data).

The one or more generative models 90 can be trained to process input data and generate model-generated content items, which may include a plurality of predicted words, pixels, signals, and/or other data. The model-generated content items may include novel content items that are not the same as any pre-existing work. The one or more generative models 90 can leverage learned representations, sequences, and/or probability distributions to generate the content items, which may include phrases, storylines, settings, objects, characters, beats, lyrics, and/or other aspects that are not included in pre-existing content items.

The one or more generative models 90 may include a vision language model.

The vision language model can be trained, tuned, and/or configured to process image data and/or text data to generate a natural language output. The vision language model may leverage a pre-trained large language model (e.g., a large autoregressive language model) with one or more encoders (e.g., one or more image encoders and/or one or more text encoders) to provide detailed natural language outputs that emulate natural language composed by a human.

The vision language model may be utilized for zero-shot image classification, few shot image classification, image captioning, multimodal query distillation, multimodal question and answering, and/or may be tuned and/or trained for a plurality of different tasks. The vision language model can perform visual question answering, image caption generation, feature detection (e.g., content monitoring (e.g., for inappropriate content)), object detection, scene recognition, and/or other tasks.

The vision language model may leverage a pre-trained language model that may then be tuned for multimodality. Training and/or tuning of the vision language model can include image-text matching, masked-language modeling, multimodal fusing with cross attention, contrastive learning, prefix language model training, and/or other training techniques. For example, the vision language model may be trained to process an image to generate predicted text that is similar to ground truth text data (e.g., a ground truth caption for the image). In some implementations, the vision language model may be trained to replace masked tokens of a natural language template with textual tokens descriptive of features depicted in an input image. Alternatively and/or additionally, the training, tuning, and/or model inference may include multi-layer concatenation of visual and textual embedding features. In some implementations, the vision language model may be trained and/or tuned via jointly learning image embedding and text embedding generation, which may include training and/or tuning a system to map embeddings to a joint feature embedding space that maps text features and image features into a shared embedding space. The joint training may include image-text pair parallel embedding and/or may include triplet training. In some implementations, the images may be utilized and/or processed as prefixes to the language model.

The one or more generative models 90 may be stored on-device and/or may be stored on a server computing system. In some implementations, the one or more generative models 90 can perform on-device processing to determine suggested searches, suggested actions, and/or suggested prompts. The one or more generative models 90 may include one or more compact vision language models that may include less parameters than a vision language model stored and operated by the server computing system. The compact vision language model may be trained via distillation training. In some implementations, the visional language model may process the display data to generate suggestions. The display data can include a single image descriptive of a screenshot and/or may include image data, metadata, and/or other data descriptive of a period of time preceding the current displayed content (e.g., the applications, images, videos, messages, and/or other content viewed within the past 30 seconds). The user computing device may generate and store a rolling buffer window (e.g., 30 seconds) of data descriptive of content displayed during the buffer. Once the time has elapsed, the data may be deleted. The rolling buffer window data may be utilized to determine a context, which can be leveraged for query, content, action, and/or prompt suggestion.

In some implementations, the generative models 90 can include machine-learned sequence processing models. An example system can pass inputs to sequence processing models. Sequence processing models can include one or more machine-learned components. Sequence processing models can process the data from inputs to obtain an input sequence. Input sequence can include one or more input elements obtained from inputs. The sequence processing model can process the input sequence using prediction layers to generate an output sequence. The output sequence can include one or more output elements generated based on input sequence. The system can generate outputs based on output sequence.

Sequence processing models can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, Google, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, arXiv: 2010.11929v2 (Jun. 3, 2021), audio domains, see, e.g., Agostinelli et al., MusicLM: Generating Music From Text, arXiv: 2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing models can process one or multiple types of data simultaneously. Sequence processing models can include relatively large models (e.g., more parameters, computationally expensive, etc.), relatively small models (e.g., fewer parameters, computationally lightweight, etc.), or both.

In general, sequence processing models can obtain an input sequence using data from inputs. For instance, input sequence can include a representation of data from inputs 2 in a format understood by sequence processing models. One or more machine-learned components of sequence processing models can ingest the data from inputs, parse the data into pieces compatible with the processing architectures of sequence processing models (e.g., via “tokenization”), and project the pieces into an input space associated with prediction layers (e.g., via “embedding”).

Sequence processing models can ingest the data from inputs and parse the data into a sequence of elements to obtain input sequence. For example, a portion of input data from inputs can be broken down into pieces that collectively represent the content of the portion of the input data. The pieces can provide the elements of the sequence.

In some implementations, processing the input data can include tokenization. For example, a tokenizer may process a given portion of an input source and output a series of tokens (e.g., corresponding to input elements) that represent the portion of the input source. Various approaches to tokenization can be used. For instance, textual input sources can be tokenized using a byte-pair encoding (BPE) technique. See, e.g., Kudo et al., SentencePiece: A simple and language independent subword tokenizer and detokenizer for Neural Text Processing, Proceedings of the 2018 Conference on Empirical Methods in Natural Language Processing (System Demonstrations), pages 66-71 (Oct. 31-Nov. 4, 2018), https://aclanthology.org/D18-2012.pdf. Image-based input sources can be tokenized by extracting and serializing patches from an image.

In general, arbitrary data types can be serialized and processed into an input sequence.

Prediction layers can predict one or more output elements based on the input elements. Prediction layers can include one or more machine-learned model architectures, such as one or more layers of learned parameters that manipulate and transform the inputs to extract higher-order meaning from, and relationships between, input elements. In this manner, for instance, example prediction layers can predict new output elements in view of the context provided by input sequence.

Prediction layers can evaluate associations between portions of input sequence and a particular output element. These associations can inform a prediction of the likelihood that a particular output follows the input context. For example, consider the textual snippet, “The carpenter's toolbox was small and heavy. It was full of.” Example prediction layers can identify that “It” refers back to “toolbox” by determining a relationship between the respective embeddings. Example prediction layers can also link “It” to the attributes of the toolbox, such as “small” and “heavy.” Based on these associations, prediction layers can, for instance, assign a higher probability to the word “nails” than to the word “sawdust.”

A transformer is an example architecture that can be used in prediction layers. See, e.g., Vaswani et al., Attention Is All You Need, arXiv: 1706.03762v7 (Aug. 2, 2023). A transformer is an example of a machine-learned model architecture that uses an attention mechanism to compute associations between items within a context window. The context window can include a sequence that contains input sequence and potentially one or more output elements. A transformer block can include one or more attention layers and one or more post-attention layers (e.g., feedforward layers, such as a multi-layer perceptron).

Prediction layers can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layers can leverage various kinds of artificial neural networks that can understand or generate sequences of information.

Output sequence can include or otherwise represent the same or different data types as input sequence. For instance, input sequence can represent textual data, and output sequence can represent textual data. The input sequence can represent image, audio, or audiovisual data, and output sequence can represent textual data (e.g., describing the image, audio, or audiovisual data). It is to be understood that prediction layers, and any other interstitial model components of sequence processing models, can be configured to receive a variety of data types in input sequences and output a variety of data types in output sequences.

The output sequence can have various relationships to an input sequence. Output sequence can be a continuation of input sequence. The output sequence can be complementary to the input sequence. The output sequence can translate, transform, augment, or otherwise modify input sequence. The output sequence can answer, evaluate, confirm, or otherwise respond to input sequence. The output sequence can implement (or describe instructions for implementing) an instruction provided via an input sequence.

The output sequence can be generated autoregressively. For instance, for some applications, an output of one or more prediction layers can be passed through one or more output layers (e.g., softmax layer) to obtain a probability distribution over an output vocabulary (e.g., a textual or symbolic vocabulary) conditioned on a set of input elements in a context window. In this manner, for instance, the output sequence can be autoregressively generated by sampling a likely next output element, adding that element to the context window, and re-generating the probability distribution based on the updated context window, and sampling a likely next output element, and so forth.

The output sequence can also be generated non-autoregressively. For instance, multiple output elements of the output sequence can be predicted together without explicit sequential conditioning on each other. See, e.g., Saharia et al., Non-Autoregressive Machine Translation with Latent Alignments, arXiv: 2004.07437v3 (Nov. 16, 2020).

The output sequence can include one or multiple portions or elements. In an example content generation configuration, the output sequence can include multiple elements corresponding to multiple portions of a generated output sequence (e.g., a textual sentence, values of a discretized waveform, computer code, etc.). In an example classification configuration, the output sequence can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

The output determination system 80 may process the one or more datasets and/or the output(s) of the sensor processing system 60 with a data augmentation block 92 to generate augmented data. For example, one or more images can be processed with the data augmentation block 92 to generate one or more augmented images. The data augmentation can include data correction, data cropping, the removal of one or more features, the addition of one or more features, a resolution adjustment, a lighting adjustment, a saturation adjustment, and/or other augmentation.

In some implementations, the one or more datasets and/or the output(s) of the sensor processing system 60 may be stored based on a data storage block 94 determination.

The output(s) of the output determination system 80 can then be provided to a user via one or more output components of the user computing device 52. For example, one or more user interface elements associated with the one or more outputs can be provided for display via a visual display of the user computing device 52.

The processes may be performed iteratively and/or continuously. One or more user inputs to the provided user interface elements may condition and/or affect successive processing loops.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computing system for search result distillation, the system comprising:
one or more processors; and
one or more non-transitory computer-readable media that collectively store instructions that, when executed by the one or more processors, cause the computing system to perform operations, the operations comprising:
obtaining a query, wherein the query comprises a plurality of features;
processing the query with a search engine to determine a plurality of search results based on the plurality of features;
processing the query with a classification model to determine a query classification descriptive of a particular query type of a plurality of different query types;
in response to the query classification being descriptive of the particular query type, processing the query, a subset of plurality of search results, and a particular prompt with a generative model to generate a plurality of sub-topics and a plurality of sub-topic queries, wherein the plurality of sub-topics are associated with a topic of information responsive to the query, and wherein the plurality of sub-topic queries are associated with the plurality of sub-topics;
processing the plurality of sub-topic queries to determine a plurality of sub-topic search result sets, wherein each of the plurality of sub-topic search result sets is associated with a different sub-topic query of the plurality of sub-topic queries;
processing the query, the plurality of sub-topics, and the plurality of sub-topic search result sets with the generative model to generate a multi-part response comprising a plurality of sub-topic headers and a plurality of sub-topic descriptions; and
providing the multi-part response for display in a search results interface.

2. The system of claim 1, wherein the operations further comprise:
processing the query with a first query classification model to determine a first query classification; and
determining to provide the query to the classification model based on the first query classification.

3. The system of claim 2, wherein the operations further comprise:
providing the query and the subset of plurality of search results to the generative model based on the first query classification;
processing the query and the subset of plurality of search results with the generative model to generate a first model-generated response, wherein the first model-generated response comprises a response to the query generated based on the content of the subset of plurality of search results; and
providing the first model-generated response for display within the search results interface.

4. The system of claim 1, wherein the operations further comprise:
before processing the query, the subset of the plurality of search results, and the particular prompt with the generative model to generate the plurality of sub-topics and the plurality of sub-topic queries:
providing a portion of the plurality of the search results for display with a selectable user interface element associated with preforming generative model processing.

5. The system of claim 4, wherein the operations, further comprise:
obtaining a selection of the selectable user interface element; and
providing the query, the subset of the plurality of search results, and the particular prompt to the generative model based on the selection.

6. The system of claim 1, wherein providing the multi-part response for display in the search results interface comprises:
providing the multi-part response for display with a portion of the plurality of search results.

7. The system of claim 1, wherein processing the query, the plurality of sub-topics, and the plurality of sub-topic search result sets with the generative model to generate the multi-part response comprises:
generating an introduction and a conclusion comprising information responsive to the query;
generating the plurality of sub-topic headers based on the plurality of sub-topics;
generating the plurality of sub-topic descriptions based on the plurality of sub-topic search result sets; and
generating the multi-part response comprising a structured format of the introduction, the plurality of sub-topic headers, the plurality of sub-topic descriptions, and the conclusion.

8. The system of claim 1, wherein the plurality of sub-topic queries comprise a plurality of model-generated queries generated to obtain information associated with the plurality of sub-topics.

9. The system of claim 1, wherein the plurality of sub-topic search result sets are determined based on one or more knowledge graphs.

10. The system of claim 1, wherein the multi-part response comprises the plurality of sub-topic headers are presented in bold, wherein the plurality of sub-topic descriptions are collapsable within the search results interface, and wherein each of the plurality of sub-topic descriptions are presented with one or more respective search results from the plurality of sub-topic search result sets.

11. A computer-implemented method, the method comprising:
receiving, by a computing system with one or more processors, a user query;
generating, by the computing system, a first model input to a generative model based on the user query;
receiving, by the computing system, a first model output from the generative model;
transmitting, by the computing system, the first model output for display to a user in a user interface;
receiving, by the computing system, a simplification request associated with the first model output;
generating, by the computing system, a second model input, the in second model input including one or more instructions to provide a simplified explanation of the first model input;
receiving, by the computing system, a second model output from the generative model, the second model output comprising a simplified version of the first model output; and
transmitting, by the computing system, the second model output for display to a user in a user interface.

12. The computer-implemented method of claim 11, wherein the first model input is a prompt.

13. The computer-implemented method of claim 12, wherein the first prompt includes the user query, instructions for generating the first model output, and contextual information.

14. The computer-implemented method of claim 13, wherein the contextual information include user profile information.

15. The computer-implemented method of claim 11, the method further comprises:
determining, by the computing system, that the user query is associated with education; and
in response to determining that the user query is associated with education, transmitting, by the computing system, instructions to update the user interface to include a simplification user interface element.

16. The computer-implemented method of claim 15, wherein when a user selects the interface element associated with requesting simplification, the computing system generates a simplification request.

17. The computer-implemented method of claim 12, wherein the second prompt includes instructions to provide a simpler explanation of the first model output.

18. The computer-implemented method of claim 17, wherein the second prompt includes instructions to provide an explanation that includes one or more of analogies, stories, visual, and real-world examples.

19. The computer-implemented method of claim 11, wherein transmitting, by the computing system, the second model output for display to a user in a user interface comprises:
updating, by the computing system, to replace the first model output with the second model output in the user interface.

20. The computer-implemented method of claim 11, wherein the generative model is a sequence processing model.
